(19) United States
(12) Patent Application Publication
(10) Pub. No.: US 2026/0352692 A1
(43) Pub. Date: Nov. 5, 2026

(54) SYSTEMS AND METHODS FOR AI-POWERED SECURITY ASSESSMENT AND ATTACK SURFACE MONITORING

(71) Applicant: CANIMA, INC., Dover, DE (US)

(72) Inventor: Elias Adrian Marquez, III, Dover, DE (US)

(21) Appl. No.: 19/565,098

(22) Filed: Mar. 12, 2026

Related U.S. Application Data
(60) Provisional application No. 63/770,904, filed on Mar. 12, 2025.

(51) Int. Cl. H04L 9/40

(52) U.S. Cl. CPC H04L 63/1433; H04L 63/0272

(57) ABSTRACT

A system and method for AI-driven network security assessment are disclosed. A penetration testing request is received via an API and scheduled for execution. The system initiates reconnaissance on a target system, analyzing the collected data using a machine learning model enhanced with reinforcement learning from human feedback. Based on the analyzed reconnaissance data, the system identifies potential vulnerabilities and executes controlled exploit attempts to validate security risks. A security report is generated detailing the findings and recommended mitigation strategies. The system dynamically updates its machine learning model using external security intelligence feeds to enhance accuracy and effectiveness.

### CROSS-REFERENCE TO RELATED APPLICATION

This Patent Application claims priority to U.S. Provisional Patent Application No. 63/770,904, filed on Mar. 12, 2025, the disclosure of which is incorporated herein by reference in its entirety for all purposes.

### TECHNICAL FIELD

The present disclosure relates generally to cybersecurity and network vulnerability assessment and, more specifically, to systems and methods for AI-driven network and web application penetration testing and attack surface monitoring.

### BACKGROUND

As cybersecurity threats continue to evolve, organizations face increasing challenges in securing their networks, monitoring attack surfaces, and conducting effective penetration testing. Ensuring comprehensive security assessments requires real-time analysis, adaptive AI-driven threat detection, and automated security orchestration.

U.S. Patent Publication No. 2021/0352100 describes a penetration testing system utilizing a security assessment engine to detect network vulnerabilities. However, its approach does not integrate real-time AI adaptation or autonomous mitigation strategies, limiting its ability to respond dynamically to emerging threats.

U.S. Patent No. 11,777,979 discloses an AI-enhanced security orchestration platform that assists in threat identification but lacks full automation of attack surface monitoring and penetration testing workflows, requiring significant manual intervention.

U.S. Patent No. 11,507,673 details a cloud-based penetration testing system incorporating vulnerability scanning and security reporting. However, its architecture does not provide real-time AI-driven decision-making or adaptive penetration testing methodologies.

Accordingly, there is a need for improved systems and methods for AI-powered penetration testing, automated attack surface monitoring, and dynamic security threat analysis that leverage advanced machine learning, command-and-control (C2) infrastructures, and intelligent cybersecurity adaptation.

### SUMMARY

A network security system is provided, incorporating a structured framework for executing automated penetration testing and vulnerability analysis. The system receives security assessment requests via an API and schedules them for execution through an integrated scheduler. The reconnaissance phase gathers data on potential weaknesses, which is analyzed using a machine learning model trained with reinforcement learning. The system then determines vulnerabilities and executes controlled exploit attempts in a secure environment. A comprehensive security report is generated, providing an assessment of risks along with recommended mitigation strategies.

A method for executing AI-driven penetration testing is provided. The process begins by receiving security assessment requests and scheduling penetration tests for execution. Reconnaissance operations are initiated to gather intelligence about network vulnerabilities, and the collected data is analyzed using an AI model that leverages reinforcement learning. If vulnerabilities are detected, controlled exploit attempts are performed in a sandboxed testing environment to assess their impact. The results are compiled into a structured security report, which is stored for access through a client portal or transmitted to administrators for further evaluation.

A computer-readable medium stores instructions that enable an AI-driven security assessment system to execute penetration testing workflows. The stored instructions facilitate the reception of security test requests via an API, schedule and manage reconnaissance operations, analyze security data using a machine learning model, and perform controlled exploit attempts to validate identified vulnerabilities. The system continuously updates its AI model using real-time security intelligence feeds. A final security report is generated, outlining detected vulnerabilities and recommended remediation steps.

### BRIEF DESCRIPTION OF THE DRAWINGS

The foregoing summary, as well as the following detailed description, is better understood when read in conjunction with the accompanying drawings. The accompanying drawings, which are incorporated herein and form part of the specification, illustrate a plurality of embodiments and, together with the description, further serve to explain the principles involved and to enable a person skilled in the relevant art(s) to make and use the disclosed technologies.

FIG. 1 is a diagram illustrating a high-level cybersecurity testing infrastructure overview depicting system components including a security management portal, an AI security analysis engine, command-and-control systems, and data processing modules used to coordinate automated penetration testing and attack surface monitoring.

FIGS. 2A–2B form a diagram illustrating a cybersecurity platform infrastructure network architecture showing connectivity between client environments, penetration testing modules, job schedulers, and AI-driven security operations.

FIG. 3 is a diagram illustrating a secure penetration testing network highlighting communication channels, network segmentation, administrative groups, penetration testing environments, and AI-based security tools.

FIGS. 4A–4C are diagrams illustrating examples of a cybersecurity platform user interaction workflow depicting authentication, dashboard access, asset management, vulnerability tracking, and security analysis features.

FIG. 5 is a flowchart illustrating an external attack surface monitoring (ASM) workflow detailing the process for detecting security vulnerabilities through automated data collection, AI-based threat analysis, and reporting mechanisms.

FIG. 6 is a flowchart illustrating a high-level command-and-control penetration testing workflow demonstrating how penetration testing requests are processed, executed, and analyzed using automated decision models and load-balanced C2 operations.

FIGS. 7A–7C illustrate a flowchart of an internal network testing workflow outlining reconnaissance, vulnerability assessment, exploitation, and reporting phases in AI-assisted penetration testing.

FIGS. 8A–8B illustrate a flowchart of a web application security testing workflow showing how automated security assessments analyze vulnerabilities, perform exploit simulations, and generate structured security reports.

FIG. 9 is a diagram illustrating an example of an AI model training and tokenization pipeline used to enhance automated security assessment and penetration testing operations.

FIG. 10 illustrates an example AI update engine system configured to automatically gather cybersecurity intelligence and update knowledge repositories used by the penetration testing platform.

FIG. 11 illustrates an example distributed worker architecture for executing automated penetration testing operations using specialized artificial intelligence agents.

FIG. 12 illustrates an example specialized artificial intelligence (AI) agent architecture 1200 used within the automated penetration testing platform.

FIG. 13 illustrates an example pipeline for generating specialized artificial intelligence models used by the automated penetration testing platform

FIGS. 14A-14B illustrates an example automated penetration testing engagement workflow, which may govern the scheduling, orchestration, execution, validation, and completion of penetration testing activities within the platform.

FIG. 15 illustrates an example research and development artificial intelligence agent workflow for generating, validating, and incorporating cybersecurity intelligence, exploit techniques, payloads, and laboratory-tested penetration testing knowledge into the platform.

FIG. 16 illustrates an example automated penetration testing and attack surface management system architecture.

FIG. 17 illustrates example user interface screens for accessing an AI-driven network security assessment platform.

FIG. 18 illustrates an example dashboard interface of the AI-driven network security assessment platform.

FIG. 19 illustrates an example analytics interface configured to present security assessment analytics.

FIG. 20 illustrates an example asset management interface for managing assets associated with a target environment.

FIG. 21 illustrates an example attack surface monitoring interface.

FIG. 22 illustrates an example external penetration testing interface.

FIG. 23 illustrates an example web application testing interface.

FIG. 24 illustrates an example internal network testing interface.

FIG. 25 illustrates an example administrative interface for managing organizational configuration.

FIG. 26 illustrates an example user settings interface for managing user profile information and preferences.

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

### DETAILED DESCRIPTION

The detailed description set forth below in connection with the appended drawings is intended as a description of configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

The system for AI-driven network security assessment may comprise a processor and a memory storing instructions that, when executed by the processor, may enable various components to perform security assessments using artificial intelligence (AI) and machine learning.

In some embodiments, the system may receive a penetration testing request via an API. This API may act as a communication interface between external clients and the security assessment system, allowing penetration tests to be initiated based on user inputs or automated triggers. The system may include a scheduler configured to manage the execution of penetration tests, ensuring that tests are conducted at predefined intervals or on demand.

Once a penetration testing request is received, the system may initiate reconnaissance on a target system. The reconnaissance phase may include scanning external attack surfaces, web applications, application programming interfaces (APIs), cloud services, and internal network environments to gather information about network assets, exposed endpoints, open ports, running services, and potential vulnerabilities. In some embodiments, the reconnaissance process may include enumeration of web application routes, API endpoints, authentication mechanisms, and service configurations associated with externally accessible infrastructure. The collected reconnaissance data may then be analyzed using a machine learning model that incorporates reinforcement learning from human feedback (RLHF). This artificial intelligence model may dynamically adjust security assessment parameters, scanning strategies, and exploitation workflows based on past penetration test results, historical vulnerability patterns, and real-time security intelligence..

In some embodiments, the penetration testing platform may dynamically adapt testing methodologies based on information discovered during reconnaissance and vulnerability analysis. Traditional automated penetration testing systems often rely on predefined scripts or rule-based testing logic that execute fixed testing sequences. In contrast, the AI-driven platform described herein may determine appropriate testing strategies during execution by analyzing intermediate results and selecting subsequent attack techniques based on detected system characteristics. This adaptive reasoning process may allow the system to identify exploit paths and vulnerability chains that would not be detected through predefined rule-based testing workflows.

After analyzing the reconnaissance data, the system may determine potential vulnerabilities within the target network. Identified vulnerabilities may be further evaluated through controlled exploit attempts executed within a sandboxed virtual environment. The sandbox environment may allow for safe testing of exploit techniques while preventing unintended disruptions to operational systems.

To enhance security and protect sensitive communications, the system may incorporate a virtual private network (VPN) infrastructure in some embodiments to provide secure communication between penetration testing environments and analysis modules. The VPN infrastructure may facilitate secure data exchange between different testing environments, ensuring that all penetration test results and vulnerability reports remain protected from unauthorized access. In other embodiments, secure communication may instead be implemented using segmented network architectures, encrypted API connections, internal service meshes, or other protected network interfaces. For example, in some implementations penetration testing components and AI-driven security analysis modules may communicate through authenticated internal services operating within a protected infrastructure environment. The secure communication architecture may operate across distributed computing environments including cloud infrastructure, on-premise security testing environments, and hybrid network deployments.

Following the execution of the penetration test, the system may generate a comprehensive security report. This report may include risk classification, exploit success probability, and recommended mitigation strategies. The generated report may be stored in a database and made accessible through a client portal, allowing administrators and security professionals to review findings and take appropriate remediation actions.

Additionally, the system may integrate external security intelligence feeds into the machine learning model, enabling real-time adaptation to emerging cybersecurity threats. By continuously updating its threat detection algorithms, the system may improve its ability to identify and respond to new vulnerabilities, ensuring a proactive security approach. These intelligence feeds may include structured vulnerability databases, dark web monitoring data, zero-day exploit disclosures, and other cybersecurity threat reports.

In some embodiments, the system may further enhance its analysis through Retrieval-Augmented Generation (RAG) techniques. Using RAG, the system may dynamically retrieve relevant threat intelligence data from internal databases, external feeds, and historical penetration test results. The retrieved data may be fused directly into AI-generated analysis, enabling the system to contextualize new vulnerabilities based on evolving threat patterns. This approach may enhance the relevance and accuracy of penetration testing strategies, risk prioritization, and mitigation recommendations by ensuring that the system’s knowledge base remains continuously refreshed with the latest security intelligence.

In some embodiments, the system may maintain a hybrid security knowledge database combining both vectorized data storage and graph-based relational storage. The hybrid architecture may allow the system to store both embedded semantic knowledge and structured vulnerability relationships within a unified retrieval framework.

Vector representations of penetration testing knowledge may be generated from structured and unstructured data sources including vulnerability databases, exploit documentation, penetration testing reports, and threat intelligence feeds. These vector embeddings may enable semantic similarity searches that allow AI agents to retrieve relevant security knowledge during penetration testing analysis.

The vector database may operate in conjunction with a relational graph database that stores explicit relationships between vulnerabilities, exploit techniques, affected technologies, and network entities. During reasoning operations, an AI agent may first perform a vector similarity search to identify relevant knowledge entries and may then expand the search through relational traversal of the graph database to identify related vulnerabilities, attack paths, or exploit techniques.

By combining semantic vector search with relational graph traversal, the system may provide a retrieval-augmented reasoning framework that improves the accuracy and contextual relevance of AI-driven penetration testing analysis.

In some embodiments, the system may also include a command-and-control (C2) infrastructure to facilitate penetration test execution, manage security task distribution, and coordinate multiple assessment workflows. The system’s AI model may further refine security testing methodologies based on continuous learning from penetration test outcomes and external threat intelligence. This continuous learning process may be further enhanced by the system’s ability to ingest real-time data feeds that capture new and emerging threats, including zero-day vulnerabilities, evolving attack techniques, and intelligence gathered from both open-source and proprietary threat monitoring services. By incorporating these up-to-date insights, the system may dynamically adjust its penetration testing strategies to proactively simulate and assess the latest attack vectors before they are widely exploited.

In some embodiments, the AI-driven security analysis engine may utilize a distributed architecture comprising multiple specialized artificial intelligence agents rather than relying on a single monolithic model. Each agent may be configured to perform a particular category of penetration testing analysis. For example, certain agents may specialize in reconnaissance analysis, vulnerability classification, exploit path discovery, web application vulnerability testing, or credential abuse detection. By dividing the penetration testing workflow among multiple specialized agents, the system may improve reasoning accuracy while reducing contextual overload within any individual model. Each agent may therefore operate as a domain-specific reasoning component that contributes to the overall penetration testing workflow.

In some embodiments, each artificial intelligence agent may operate within predefined guardrails that restrict the scope of its operation to a specific penetration testing engagement. These guardrails may prevent the agent from accessing data associated with other engagements or unrelated client environments. For example, project identifiers, asset scopes, and permitted testing parameters may be embedded within the execution context of each agent. By enforcing scope restrictions at the infrastructure level rather than relying solely on AI reasoning, the system may prevent cross-project data access, reduce the risk of task poisoning, and improve overall operational security.

In some embodiments, penetration testing tasks may be executed by distributed worker processes that retrieve job instructions from a centralized job queue. Each worker process may claim ownership of a penetration testing task and execute the corresponding security analysis operations. While executing a task, the worker may periodically update the task status within the job queue. If a worker process becomes unavailable or fails to complete the task within a defined interval, the job queue may automatically release the task so that another worker process can resume execution. This distributed execution model may provide scalability and fault tolerance while ensuring that penetration testing engagements can continue even if individual worker nodes fail.

In some embodiments, the system may maintain multiple knowledge repositories that support AI-driven penetration testing operations. A first repository may include a hybrid knowledge database combining vectorized semantic data and graph-based relational data. Vector embeddings may represent penetration testing knowledge derived from vulnerability databases, exploit repositories, historical penetration test results, and threat intelligence feeds. These vector embeddings may enable semantic similarity searches that allow artificial intelligence agents to retrieve relevant security knowledge during analysis. The vector database may operate in conjunction with a relational graph database that stores explicit relationships between vulnerabilities, attack techniques, exploit tools, and defensive mitigations.

In addition to the hybrid knowledge repository, the system may maintain a project-specific knowledge graph representing the evolving structure of a target environment during an active penetration test. The project knowledge graph may be implemented using a graph database platform such as Neo4j, FalkorDB, or similar graph-oriented data stores capable of supporting Cypher or comparable graph query languages. Nodes within the project knowledge graph may represent discovered assets, hosts, network services, open ports, software versions, credentials, user accounts, or other security-relevant entities, while edges may represent relationships such as connectivity, privilege escalation paths, service dependencies, or vulnerability linkages.

During operation, AI agents may interact with the project knowledge graph to record discoveries, update relationships between assets, and construct potential attack paths as testing progresses. Queries to the graph database may be performed using graph traversal operations or Cypher-style query languages that enable the AI agent to analyze relationships between hosts, services, vulnerabilities, and credentials. The project knowledge graph may therefore serve as a dynamic representation of the target environment that evolves as reconnaissance, enumeration, and exploitation activities proceed.

In some embodiments, reasoning operations performed by the AI agent may combine both repositories. The agent may retrieve relevant penetration testing knowledge from the hybrid vector-graph knowledge repository using semantic similarity search, and may then apply that knowledge to the project knowledge graph by analyzing relationships between discovered assets and potential exploit paths. This combination of semantic retrieval and environment-specific graph analysis may enable the system to identify likely attack chains, prioritize exploitation opportunities, and adapt penetration testing strategies based on the evolving structure of the target network.

Overall, the system may provide a scalable, AI-powered solution for automated network security assessment, penetration testing, and vulnerability analysis, allowing organizations to identify and mitigate potential threats in a proactive and efficient manner.

In some embodiments, the AI-driven security assessment platform may utilize a distributed architecture of specialized artificial intelligence agents. Rather than relying on a single large artificial intelligence model to perform all penetration testing tasks, the system may deploy multiple specialized AI agents, each responsible for a particular domain of security analysis. These agents may include, for example, agents dedicated to cross-site scripting (XSS) analysis, authentication bypass detection, privilege escalation analysis, exploit path planning, or vulnerability chain identification. By distributing responsibilities across specialized AI agents, the system may improve accuracy, reduce reasoning complexity, and allow each agent to function as a domain-specific expert within its assigned security discipline.

The use of multiple specialized AI agents may reduce performance degradation associated with large contextual workloads. When a single AI model attempts to track an entire penetration testing engagement, contextual information may become excessively large or degrade over time, which may reduce reasoning accuracy. By assigning smaller and specialized reasoning tasks to independent AI agents, each agent may maintain a focused context window and avoid loss of analytical precision. This architecture may reduce contextual drift and improve the reliability of automated vulnerability detection and exploit simulation processes.

In some embodiments, the AI agents may be coordinated through a multi-agent orchestration framework that manages communication between agents and available security tools. The orchestration framework may manage agent interactions, task sequencing, and execution of external security utilities. For example, an orchestration layer may allow one agent to perform reconnaissance, another to analyze vulnerability conditions, and another to simulate exploit execution. The orchestration system may also coordinate data exchange between agents and the underlying penetration testing infrastructure.

In some embodiments, the AI agents may operate within predefined security guardrails that restrict agent behavior and protect against unintended actions. These guardrails may prevent the AI agents from performing unauthorized operations, interacting with data outside of an assigned project scope, or accessing unrelated client environments. For example, the system may enforce strict project-level isolation by embedding target parameters directly into agent tool interfaces and execution environments. By incorporating project scope restrictions directly into system architecture, the AI agents may be prevented from executing actions outside of their assigned engagement.

The guardrail mechanisms may further protect against adversarial attacks intended to manipulate AI reasoning processes. Such attacks may include prompt injection, data poisoning attempts, contextual drift, or task manipulation. The system may enforce guardrails at multiple layers including agent reasoning prompts, tool execution interfaces, database query restrictions, and infrastructure access controls. These safeguards may ensure that AI agents operate within defined security boundaries and remain resistant to malicious input designed to alter their operational behavior.

In some embodiments, the system may leverage a command-and-control (C2) or task orchestration infrastructure to facilitate structured execution of security assessments. The orchestration framework may coordinate distributed testing components and manage execution of penetration testing tasks across multiple scanning agents or analysis modules. In some implementations, the orchestration infrastructure may include message brokers, distributed job queues, or task management systems such as Redis-based queues, message streaming systems, or similar scheduling frameworks capable of coordinating asynchronous testing operations. When a penetration testing request is received, the system may authenticate the request via an API, validating client credentials, project identifiers (PRJ IDs), and other security-relevant metadata.

Once authenticated, the system may retrieve the necessary penetration test configurations, which may include:
Scope of testing, defining permitted and restricted areas within the network.
Rules of Engagement (ROE), specifying test intensity levels, such as passive reconnaissance, aggressive attack simulation, or hybrid approaches.
VPN configurations, enabling secure communication channels for controlled exploit execution.
Test scheduling parameters, dictating when and how often penetration tests should be conducted.

After validation, the system may dynamically provision a testing environment by linking the client’s infrastructure with a virtualized security instance (OVA) or other containerized execution environment. This instance may be automatically deployed and secured using an encrypted communication channel established through a configurable virtual private network (VPN) solution, which may be selected based on security requirements, client preferences, and evolving best practices.

The orchestration framework, which in some embodiments may operate as or in conjunction with a command-and-control (C2) infrastructure, may then launch a structured workflow for executing penetration testing tasks in defined phases. Individual tasks may be scheduled and distributed through the orchestration infrastructure, allowing scanning agents, exploitation modules, and analysis components to operate asynchronously while maintaining coordinated control through the C2 or task management system. Results generated by the distributed testing components may be reported back to the central system for aggregation, analysis, and reasoning by the AI analysis modules.

Reconnaissance Phase: The system may gather information about the target network, scanning attack surfaces for publicly accessible assets, open ports, and potential misconfigurations. AI security analysis engine may dynamically adjust reconnaissance strategies based on live security feedback, refining data collection methods.

Vulnerability Assessment Phase: The reconnaissance data may be processed by the system’s AI-driven analysis engine, which may cross-reference identified weaknesses with known vulnerability databases, such as the Common Vulnerabilities and Exposures (CVE) repository and proprietary security intelligence feeds. Machine learning algorithms may categorize vulnerabilities based on severity, exploitability, and real-time threat intelligence.

Exploitation Phase: Once vulnerabilities are confirmed, the system may execute controlled exploit attempts within a sandboxed testing environment. The C2 infrastructure may ensure that all exploitation attempts adhere to predefined ROE constraints, preventing unauthorized disruptions to operational systems. AI security analysis engine may monitor execution in real time, dynamically adjusting exploit parameters for optimal attack simulations. If an exploit attempt is unsuccessful, the system may refine its approach and re-execute the process until the maximum retry threshold is reached.

Logging and Data Transmission: At each stage, the system may log security events, terminal outputs, and testing results. The C2 infrastructure may package these logs and transmit them to AI security analysis engine for further analysis. This data may include, but is not limited to:
Tool output results, including responses from security scanning utilities such as Nmap, Nessus, and Burp Suite.
Credential validation logs, tracking authentication attempts and privilege escalation scenarios.
Kill chain mapping, outlining the sequential steps used to identify, exploit, and document vulnerabilities.

AI-driven assessment results, indicating whether detected vulnerabilities may require further analysis or retesting.

Automated Report Generation: Once testing is complete, AI security analysis engine may generate a structured security report. This report may include:
A summary of identified vulnerabilities and exploit attempts.A summary of identified vulnerabilities and exploit attempts.
Risk classification metrics, detailing the likelihood and potential impact of each vulnerability.
Mitigation strategies, recommending specific countermeasures to reduce security risks.
Attack narrative construction, where AI security analysis engine may compile a kill chain analysis into an easily interpretable format for security professionals.

The system may ensure that this report is accessible via the client portal, where security administrators may review findings, validate testing outcomes, and initiate corrective actions. If necessary, the system may support retest requests, enabling automated follow-up penetration tests based on prior findings.

### Adaptive Security Intelligence and Threat Response Mechanisms

In some embodiments, the system may adapt testing methodologies in real time based on security intelligence updates. The AI-driven analysis engine may continuously refine penetration testing strategies by integrating external threat feeds, monitoring dark web activity, and analyzing emerging attack patterns.

If a new exploit technique or security vulnerability is detected, the system may dynamically update its penetration testing framework to incorporate the latest threat intelligence. This adaptive learning mechanism may ensure that the system remains effective against evolving cybersecurity threats.

Additionally, the C2 infrastructure may include an emergency termination protocol, allowing security administrators to immediately halt penetration testing activities in the event of unexpected system behavior or operational conflicts. This feature may provide an added layer of control, ensuring that security assessments do not interfere with mission-critical operations.

In some embodiments, a system may receive a penetration testing request via an API. The request may originate from an external client system, an administrator, or an automated security workflow. Before processing, the request may be authenticated using multi-factor authentication, API keys, or token-based access control to ensure that only authorized users can initiate security assessments. The request may be validated to confirm that it includes all necessary parameters, such as the target system details, the scope of testing, permitted testing methodologies, and compliance restrictions. The request may then be logged in a database, allowing for tracking, auditing, and historical analysis. In some embodiments, the penetration testing request may be processed through a command-and-control (C2) infrastructure, which may manage security testing workflows and ensure that testing tasks are distributed efficiently across various security environments.

Once validated, the system may schedule the execution of the penetration test. Scheduling may involve assigning a testing window based on system availability, network conditions, and predefined security policies. The scheduler may determine whether the test should be executed locally, on cloud infrastructure, or within a hybrid environment. The request may be placed into a job queue, allowing for efficient resource allocation and prioritization based on system load, risk factors, and previous test results. In some embodiments, scheduling may be dynamically adjusted based on real-time security intelligence and machine learning predictions regarding potential vulnerabilities.

Following scheduling, the system may initiate reconnaissance on the target system. Reconnaissance may involve gathering intelligence to assess the security posture of the target. The reconnaissance phase may include scanning external attack surfaces, which may involve identifying publicly accessible assets, open ports, and misconfigurations that could expose the system to threats. The process may also include analyzing internal network environments, such as mapping network structures, identifying live hosts, and probing firewall rules. In some instances, passive intelligence gathering may be performed, incorporating open-source intelligence (OSINT) data sources to enhance threat visibility. The results of the reconnaissance phase may be stored and processed for further analysis.

Once reconnaissance data is collected, the system may analyze the data using one or more machine learning models, such as large language models (LLMs), specialized neural networks, or other artificial intelligence models that may incorporate reinforcement learning from human feedback (RLHF). The analysis may begin with feature extraction, where key attributes are identified from network scans, log files, service banners, configuration artifacts, and other security telemetry. The system may classify threats using AI-driven risk scoring models that assess the likelihood of exploitation and potential impact of identified vulnerabilities. In some embodiments, the system may utilize multiple specialized models configured for different penetration testing tasks or operational phases. For example, separate models may be used for reconnaissance analysis, vulnerability classification, exploit strategy generation, privilege escalation planning, lateral movement analysis, or post-exploitation assessment. The models may dynamically adjust security assessment parameters based on past test results, refining detection capabilities and reducing false positives. Adaptive learning techniques may also be applied, allowing the models to improve over time by incorporating new threat intelligence, historical penetration test outcomes, and feedback from security analysts.

After analyzing reconnaissance data, the system may determine potential vulnerabilities. This may involve cross-referencing identified weaknesses with known vulnerability databases, such as the Common Vulnerabilities and Exposures (CVE) repository, proprietary security feeds, or internal threat intelligence reports. The system may apply filtering mechanisms to reduce false positives by eliminating benign anomalies that do not present security risks. A risk prioritization process may be performed, categorizing vulnerabilities based on severity, exploitability, and existing security controls. High-risk vulnerabilities may be flagged for immediate testing, while lower-risk vulnerabilities may be scheduled for later analysis.

Once vulnerabilities are identified, the system may execute controlled exploit attempts to validate the security risks. The exploitation phase may be conducted within a sandboxed virtual environment to ensure that testing activities do not disrupt live systems. The system may generate tailored exploit payloads designed to assess the weaknesses identified in the reconnaissance phase. These payloads may be executed in a controlled manner, with security monitoring tools tracking system responses to determine whether an exploit is successful. If an exploit attempt fails, the system may refine its approach, modifying payload parameters based on AI-driven analysis. The system may log exploit results, capturing details on how the target system responded to the attack simulations.

Following the exploit phase, the system may generate a security report detailing findings and recommended mitigation strategies. The report may include a structured summary of detected vulnerabilities, descriptions of how each vulnerability was exploited, and an analysis of potential security impacts. The report may also provide recommended mitigation strategies, which may include patching guidance, configuration adjustments, or network segmentation recommendations. Compliance verification may be included, ensuring that the testing process aligns with security standards such as NIST, ISO 27001, or GDPR. In some embodiments, the security report may be stored in a database for future retrieval via a client portal, allowing security teams to review historical assessments and track improvements over time. Additionally, the report may be transmitted to an administrator for validation and approval, providing decision-makers with actionable insights into system vulnerabilities and potential remediation steps.

To enhance security and ensure confidentiality, the system may encrypt communications between its components using secure communication frameworks. In some embodiments, the system may employ a virtual private network (VPN) infrastructure to establish encrypted communication channels between penetration testing environments, AI-driven security analysis modules, and client systems. In other embodiments, communication between testing environments and platform components may instead occur through authenticated API interfaces, TLS/SSL encrypted connections, segmented infrastructure networks, or other protected service communication mechanisms. These communication architectures help ensure that sensitive vulnerability data, penetration testing activity, and security assessment results remain protected from unauthorized access.

The system may also integrate security intelligence feeds into its machine learning model to enable real-time adaptation. External threat feeds may be continuously fetched from cybersecurity intelligence sources, including dark web monitoring services, attack trend databases, and real-time exploit repositories. The AI model may update its threat detection algorithms based on newly discovered vulnerabilities, refining its risk assessment techniques to stay ahead of emerging cyber threats. Automated adaptation may allow the system to adjust its penetration testing techniques dynamically, ensuring that assessments remain relevant in response to evolving security landscapes.

In some embodiments, the system may rapidly incorporate newly disclosed vulnerabilities into penetration testing workflows. When new vulnerability disclosures, exploit techniques, or threat intelligence indicators are identified through external security feeds or internal research processes, the AI-driven analysis engine may integrate this information into its reasoning process without requiring manual script updates. This capability may allow the platform to identify newly disclosed vulnerabilities and emerging attack paths shortly after their publication, thereby reducing delays associated with traditional rule-based vulnerability scanning systems that require manual update cycles.

In some embodiments, the platform may include a research and development environment dedicated to generating new penetration testing knowledge. This environment may include isolated testing laboratories and automated analysis systems that evaluate newly disclosed vulnerabilities, develop exploit techniques, and analyze emerging attack paths.

The research environment may generate validated exploit techniques, attack simulations, and vulnerability analysis data. These results may be incorporated into the platform’s knowledge databases and AI training pipelines. By continuously integrating research-generated exploit intelligence, the AI-driven penetration testing agents may remain aligned with newly emerging vulnerabilities and evolving attack methodologies.

This research environment may function as an automated knowledge generation system, enabling the platform to expand its penetration testing capabilities by continuously producing new exploit data, vulnerability relationships, and attack simulations. The generated knowledge may then be integrated into the system’s knowledge graph and vector database to enhance AI-driven reasoning during penetration testing engagements.

In some embodiments, the penetration testing process may be iterative, with multiple rounds of reconnaissance, vulnerability analysis, and exploitation conducted to refine security assessments. Feedback loops may be established, allowing the AI-driven security model to learn from past testing activities and continuously improve its accuracy. The system may also incorporate collaborative intelligence, where insights from security professionals are used to enhance machine learning predictions and refine attack simulation methodologies.

Through these AI-powered penetration testing methodologies, organizations may achieve a proactive approach to cybersecurity, identifying and mitigating vulnerabilities before they can be exploited by malicious actors. By leveraging AI-driven decision-making, secure network communications, and real-time threat intelligence, the described embodiments may enable automated, adaptive, and scalable security assessments that enhance the overall resilience of enterprise networks. In some embodiments, the components described in connection with the figures may correspond to internally developed modules, third-party security tools, or cloud-based services. The naming of specific components or subsystems is provided for illustrative purposes only and does not limit the architecture of the cybersecurity testing platform.

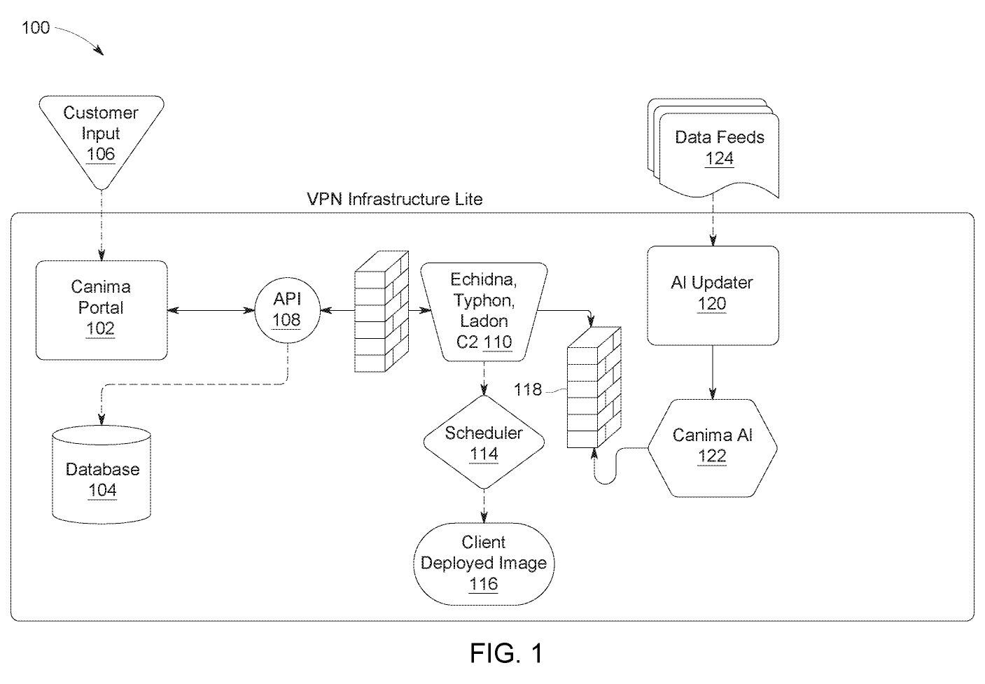

FIG. 1 is a diagram illustrating a high-level cybersecurity infrastructure overview depicting system components including a security management portal, an AI security analysis engine, command-and-control components, and data processing modules used to coordinate automated penetration testing and attack surface monitoring. FIG. 1 illustrates AI Infrastructure System 100, which may provide a structured framework for handling customer inputs, AI-driven security analysis, penetration testing orchestration, and network security management. The system may integrate multiple subsystems, including command-and-control (C2) components, secure networking, AI-driven data processing, and automation tools to enhance cybersecurity operations.

In some embodiments, AI Infrastructure System 100 may include a security management portal 102 that serves as the primary user interface for system administrators, security analysts, and automated security workflows. The portal may enable access to threat intelligence reports, penetration testing controls, network security status, and AI-driven analytics. The portal may communicate with Database 104, which may store historical security assessments, test results, and user configurations to support efficient query retrieval and system adaptability.

External customer input 106 may be processed through API 108, which may act as a middleware layer that facilitates communication between security management portal 102 and various subsystems within the infrastructure. API 108 may help ensure that security requests, penetration testing commands, and system interactions are properly structured and routed to the appropriate modules for execution.

Scheduler 114 may coordinate the system’s automated workflows by managing the execution of penetration tests, vulnerability scans, and AI-driven security evaluations at predefined intervals. Scheduler 114 may ensure that test execution remains efficient and aligned with security compliance requirements.

Command-and-control (C2) operations may be managed by Command-and-control (C2) system 110, which may handle security test orchestration, real-time threat intelligence analysis, and automated vulnerability scanning. API 108 and Command-and-control (C2) system 110 may be separated by Firewall 112, which may regulate network traffic between these components to ensure secure communication and prevent unauthorized access.

In some embodiments, the system may include an API-driven security workflow to facilitate penetration testing execution, attack surface monitoring, and external intelligence gathering. The API framework may support structured security assessment workflows, including:
Penetration Testing Execution APIs – Handling client requests, job scheduling, and security test management.
Reconnaissance and Vulnerability Analysis APIs – Integrating external attack surface monitoring tools (e.g., Shodan, Nessus).
Threat Intelligence APIs – Fetching real-time security data and attack patterns from external sources.

The API framework may implement authentication through OAuth-based access tokens, ensuring security operations are restricted to authorized entities.

The C2 components may interface with Client Deployed Image 116, which may allow penetration tests, attack simulations, and vulnerability assessments to be executed in distributed client environments.

For secure network communications, Secure communication infrastructure 118 may establish encrypted communication channels between system components, client networks, and cloud-based AI services. This may help ensure that sensitive penetration test data, customer interactions, and AI-generated insights remain protected from unauthorized access.

In some embodiments, AI Updater 120 may ensure that machine learning models, security heuristics, and AI-driven decision-making logic are continuously refined based on new threat intelligence data. AI security analysis engine 122 may process security telemetry, evaluate attack patterns, predict vulnerabilities, and optimize penetration testing strategies.

Command-and-control (C2) system 110 and AI security analysis engine 122 may be separated by Firewall 112, which may manage secure data flow between penetration testing operations and AI-driven threat analysis, preventing unauthorized system access and mitigating potential security risks.

In some embodiments, C2 controller may facilitate controlled penetration test execution, enabling secure task distribution and vulnerability analysis. The C2 system may implement:
encrypted communication channel authentication for encrypted penetration test execution.
Remote exploit execution with AI monitoring for automated security validation.
Rules of Engagement enforcement, ensuring security tests operate within predefined boundaries.

C2 controller may dynamically adjust its execution process based on live attack telemetry, enabling real-time penetration test refinement.

To support dynamic security operations, Data Feeds 124 may supply real-time security intelligence, vulnerability databases, and network threat updates to the system. These feeds may enable automated decision-making and penetration test execution adjustments in response to evolving cybersecurity risks.

In some embodiments, the system may integrate AI security analysis engine, a reinforcement learning-based penetration testing model. AI security analysis engine may leverage:
LORA-based model tuning or Full Scale Tuning for optimized security decision-making.
Adaptive data tokenization to refine security assessment workflows.
Continuous security learning, analyzing attack patterns and adjusting test strategies dynamically.

The AI model may autonomously refine penetration testing execution strategies, ensuring resilience against evolving cybersecurity threats.

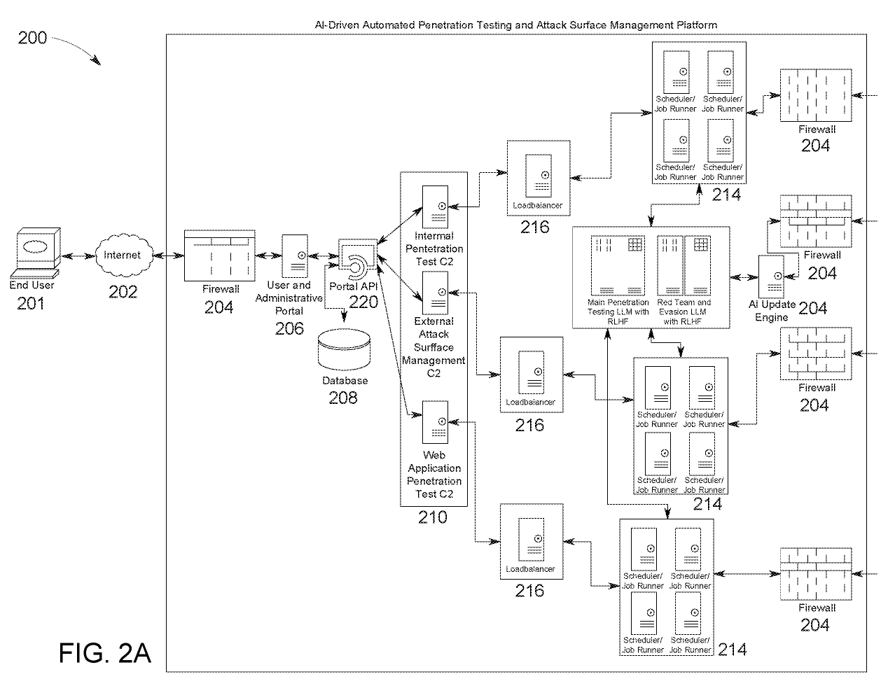

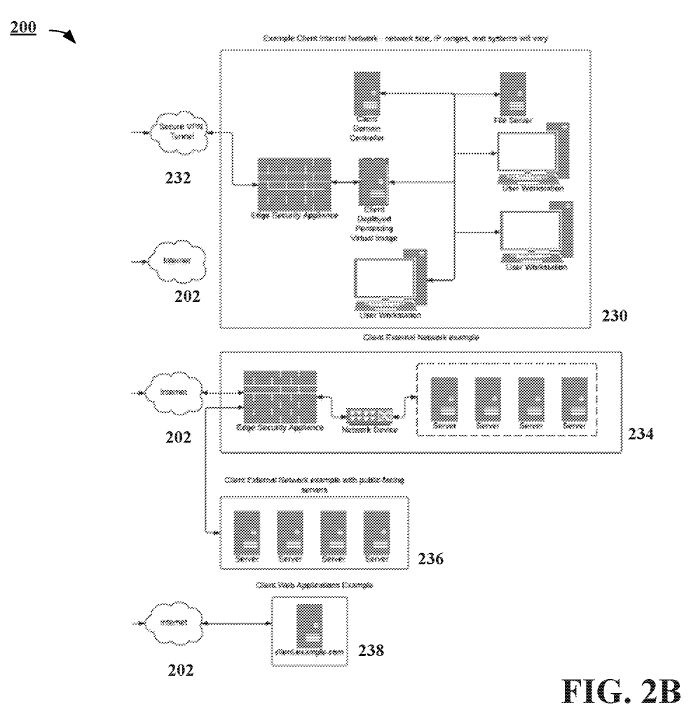

FIGS. 2A-2B illustrate AI Platform and Infrastructure Network System 200, which may facilitate automated penetration testing, attack surface monitoring, and AI-driven cybersecurity assessments. The system may integrate multiple components, including client environments, network security layers, AI-driven penetration testing engines, and automated job scheduling components to provide a comprehensive security infrastructure.

FIGS. 2A-2B present an embodiment of an AI-driven cybersecurity platform and infrastructure network designed to facilitate automated penetration testing. The system architecture may integrate multiple components, including client network environments, AI-driven security analysis modules, penetration testing orchestration, and secure communication frameworks. By leveraging artificial intelligence, machine learning, and reinforcement learning from human feedback, the system may dynamically adapt security assessments to evolving cyber threats.

Referring now to FIG. 2A, the AI Platform and Infrastructure Network System 200 may include an end user computing device 201 communicating through the Internet 202. Network traffic may pass through one or more firewall components 204 before reaching a user administrative portal 206 and associated database 208. In some embodiments, the portal API 220 may facilitate communication between external user interfaces and internal security orchestration components of the platform. The portal API 220 may allow authorized users to initiate penetration tests, configure attack surface monitoring tasks, review vulnerability results, and manage security policies associated with the platform.

In some embodiments, the AI-driven penetration testing infrastructure may include multiple command-and-control (C2) nodes 210 responsible for coordinating penetration testing operations and attack surface monitoring tasks. These nodes may communicate with one or more load balancers 216 that distribute computational workloads across clusters of job scheduler and job runner nodes 214. The job scheduler infrastructure 214 may manage the execution of automated security tasks across multiple environments, ensuring efficient allocation of resources. The AI analysis components may include penetration testing and red-team artificial intelligence models 212 that utilize reinforcement learning from human feedback (RLHF) to dynamically refine attack strategies and vulnerability detection techniques. An AI update engine 218 may further enable continuous improvement of the system by incorporating updated threat intelligence, vulnerability databases, and security heuristics. In some embodiments, firewall components 204 may be deployed at multiple network boundaries to enforce segmentation and regulate communications between system components.

Referring now to FIG. 2B, example client network environments that may be assessed by the AI Platform and Infrastructure Network System 200 are illustrated. In some embodiments, a client internal network environment 230 may include a variety of enterprise computing resources such as domain controllers, file servers, security appliances, and user workstations. Access to the internal environment may occur through a secure VPN tunnel 232 established between the client environment and the platform infrastructure. Communications between the client network and external systems may traverse the Internet 202 and may be protected by one or more edge security appliances 234 configured to regulate traffic entering or leaving the internal network environment.

FIG. 2B may further illustrate example external network environments associated with the client infrastructure. In some embodiments, a client external network environment 236 may include network infrastructure devices such as routers, gateways, and firewalls that provide connectivity to publicly accessible computing resources. These environments may host public-facing servers or services that are reachable through the Internet 202. The platform may also assess web-based assets, such as a client web application environment 238, which may represent externally accessible web applications, application programming interfaces (APIs), or cloud-hosted services subject to automated security testing and attack surface monitoring.

In some embodiments, communications between internal networks and analysis modules may be transmitted through encrypted VPN tunnels to protect penetration testing activity from external observation. In other embodiments, the system may instead rely on encrypted service-to-service communication, API authentication mechanisms, segmented infrastructure networks, or isolated execution environments that prevent unauthorized access to penetration testing data. A client’s internal network may include various computing assets such as domain controllers, file servers, security appliances, and user workstations that may be subject to continuous security monitoring and penetration testing. A client-deployed virtual penetration testing image may operate within the internal environment, enabling localized security assessments without exposing sensitive data to external systems.

To protect the network perimeter, multiple firewalls may be implemented to regulate traffic flow between different security zones, preventing unauthorized access to internal computing resources. The architecture may include an external network security framework designed to monitor public-facing assets such as web servers, APIs, and cloud services. The attack surface management (ASM) system may continuously scan these assets to detect vulnerabilities, misconfigurations, and potential attack vectors before they can be exploited by malicious actors.

At the core of the system, an AI-driven penetration testing and threat analysis platform may be responsible for orchestrating security operations. The platform may include a command-and-control (C2) infrastructure, which may coordinate penetration test execution, manage security intelligence workflows, and enforce security policies. A job scheduler may allocate security assessment tasks across multiple computing nodes, ensuring efficient utilization of resources and optimizing penetration test execution. The system may also include load balancers to distribute processing workloads across AI-driven security modules, preventing bottlenecks and ensuring real-time threat analysis.

The penetration testing framework may incorporate large language models (LLMs) with reinforcement learning from human feedback (RLHF), enabling dynamic adjustments to attack methodologies based on live network telemetry and historical test results. A red team and evasion model may enhance the AI-driven security engine, refining attack simulations and improving the accuracy of vulnerability assessments. These AI models may continuously update their knowledge base by integrating security intelligence feeds, vulnerability databases, and attack pattern analyses.

The architecture may support comprehensive web application security assessments, with a dedicated web penetration testing module capable of scanning and analyzing web-based assets for vulnerabilities such as SQL injection, cross-site scripting (XSS), authentication weaknesses, and API misconfigurations. The web application testing engine may interact with client-deployed security tools and integrate with broader penetration testing workflows to provide a holistic view of web security risks.

To ensure secure data exchange, the system may implement a communication framework that includes encrypted communication channels, firewall enforcement mechanisms, and role-based access control policies. In some embodiments, the communication framework may include VPN infrastructure that establishes encrypted tunnels between penetration testing environments, command-and-control systems, and AI-driven security analysis modules. In other embodiments, secure communication may instead be achieved through authenticated internal services, protected API gateways, or segmented infrastructure networks that isolate penetration testing components from external access. These communication mechanisms ensure that sensitive vulnerability data and penetration testing results are transmitted securely between system components.

User interaction with the platform may be facilitated through a centralized security portal, providing security professionals and administrators with access to penetration test results, vulnerability reports, and security policy configurations. The system may implement multi-factor authentication (MFA) and token-based access controls to restrict user permissions based on predefined security policies.

In some embodiments, the secure communication architecture may operate across distributed computing environments including cloud infrastructure, on-premise security testing environments, hybrid deployments, or client-hosted infrastructure.

To maintain continuous improvement, the architecture may incorporate an AI update engine responsible for refining penetration testing models, security heuristics, and risk assessment methodologies. The AI-driven update process may integrate real-time security intelligence feeds, dark web monitoring insights, and automated security correlation techniques, ensuring that penetration testing workflows remain adaptive to the latest cyber threats.

Throughout the architecture, logging and auditing mechanisms may be implemented to ensure compliance with industry standards and regulatory requirements. Security logs may capture penetration test activities, vulnerability discoveries, and exploit attempt results, providing a detailed audit trail for security teams to analyze and refine their defense strategies.

The system may also support multi-layered network segmentation, ensuring that penetration testing operations do not disrupt critical business services. By isolating security testing environments from operational networks, organizations may conduct continuous penetration testing and threat monitoring without compromising system availability or performance.

Overall, the AI-driven platform and infrastructure network depicted in FIGS. 2A-2B may provide a scalable, adaptive, and intelligence-driven approach to cybersecurity. Through automation, machine learning, and reinforcement learning, the system may enhance an organization's ability to identify and mitigate cyber threats proactively, improving overall network resilience and security posture.

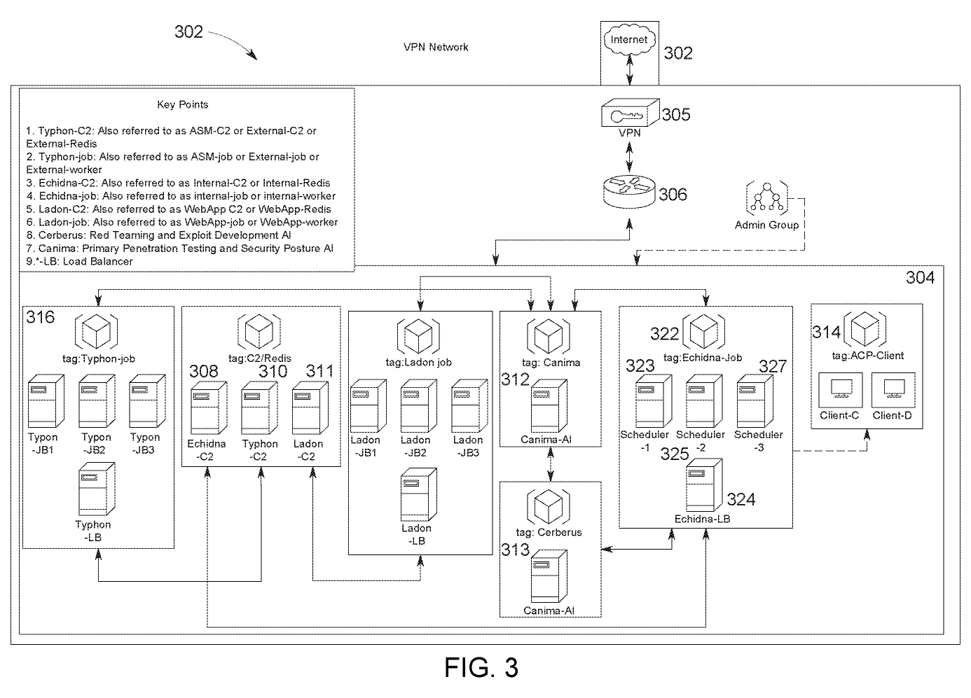

FIG. 3 is a diagram 300 illustrating the Secure testing network, highlighting secure communication channels, network segmentation, administrative groups, penetration testing environments, and AI-based security tools. FIG. 3 illustrates the Secure testing network 305, which may facilitate secure communication, penetration testing operations, and AI-driven security assessments. The system may include multiple administrative, operational, and security layers, allowing authorized users and security tools to interact securely within the Cybersecurity testing infrastructure. In some embodiments the secure network illustrated in FIG. 3 may include VPN-based connectivity, while in other embodiments the network may instead utilize segmented infrastructure environments or authenticated service communication within protected cloud or on-premise environments.

The Secure testing network 305 may provide a secure, structured environment for managing cybersecurity operations, penetration testing workflows, and AI-driven security assessments. In some embodiments, the network may be designed to support multiple administrative and operational groups, facilitating seamless communication and security task execution across distributed infrastructures.

The network may be connected to the Internet, allowing for external interactions while enforcing strict security policies to prevent unauthorized access. Within the infrastructure, different user groups may have distinct roles, ensuring efficient management of security operations. An Admin Group 304 may oversee high-level system configurations, enforce security policies, and manage the overall VPN infrastructure. A Management Group 306 may handle the coordination of penetration testing tasks, monitoring, and network security workflows.

To facilitate security testing and monitoring, the system may integrate multiple command-and-control (C2) infrastructures, such as Echidna-C2 308, Typhon-C2 310, and Ladon-C2. These infrastructures may serve as centralized orchestration points for penetration test execution, attack surface monitoring, web application assessments, and automated security testing workflows. Echidna-C2 308 may be responsible for managing internal network penetration tests, handling controlled exploit execution and security task distribution within internal environments. Typhon-C2 310 (also referred to as an external attack surface monitoring command-and-control infrastructure) may focus on tracking external vulnerabilities, performing attack surface monitoring (ASM), and processing real-time security intelligence feeds from public-facing assets. Ladon-C2 may manage web application penetration testing, coordinating targeted assessments of APIs, web services, and application-layer vulnerabilities.

The AI security analysis engine system 312 may be integrated into the network to analyze threat data, refine penetration testing strategies, and enhance the accuracy of vulnerability assessments. This AI component may dynamically adjust attack simulations based on real-time security feedback and external threat intelligence. In some embodiments, additional AI-based security modules (e.g., red-teaming orchestration engines or exploit deployment automation systems) may also be deployed within the Secure testing network 305.

Various client environments may be deployed within the network, including automated penetration testing clients (ACP-Client 314). ACP-Clients, such as Client-C and Client-D, may execute automated security testing tasks, perform reconnaissance and vulnerability analysis, and generate structured penetration testing reports. These automated client environments may interact with the platform infrastructure to execute scheduled testing operations, collect security intelligence, and report identified vulnerabilities for further analysis and remediation.

To enhance security, the network may be fully segmented, with default "deny-all" rules applied to communication between clients and systems. For example, Client-C may be fully isolated from Client-D, and systems within the same group may also be prevented from communicating with each other unless explicitly authorized by preconfigured access controls. This segmentation helps limit potential lateral movement, reducing the risk of cross-system compromise during testing activities.

Attack surface monitoring jobs may be distributed across designated environments (ASM-Job), including reconnaissance and scanning environments (e.g., Kali-1, Kali-2, and Kali-3), which may be configured for active reconnaissance, vulnerability scanning, and threat analysis. These environments may interact with the ASM command-and-control infrastructure to continuously assess network security risk.

The system may also incorporate various security testing tools included within Security Tooling, such as security assessment and exploitation frameworks (e.g., Nessus, GoPhish, EvilNginx, Exploit-Host, and P-Cracking). These tools may be used to conduct vulnerability scanning, phishing resilience testing, exploit development, credential harvesting simulations, and password security assessments.

A structured job scheduling mechanism may be employed to manage security testing tasks efficiently. The Echidna-Job Scheduler 322, which may include multiple scheduling nodes (e.g., Scheduler-1, Scheduler-2, and Scheduler-3), may allocate penetration testing resources, prioritize test execution, and ensure optimal system utilization. The Echidna LoadBalancer 324 may distribute workloads across multiple security environments, preventing bottlenecks and enabling scalable security testing operations.

A dedicated Pentester Group may be responsible for analyzing penetration test results, validating AI-generated security insights, and refining attack methodologies. Members of this group may interact with manual testing environments and specialized security tooling to perform advanced vulnerability analysis and exploit validation.

For secure communication, the system may leverage encrypted virtual private network (VPN) technologies (e.g., Tailscale) or other zero-trust networking frameworks that enable encrypted connections between security testing environments, AI-driven analysis platforms, and external client networks. This infrastructure may provide an additional layer of security, ensuring that sensitive security data, penetration test logs, and network telemetry remain protected from unauthorized access.

The Secure testing network may thus serve as a robust, AI-enhanced cybersecurity framework that integrates command-and-control infrastructures, automated security workflows, and real-time threat intelligence to facilitate comprehensive security assessments and penetration testing operations. Through its modular architecture, the system may support dynamic security testing, adaptive risk analysis, and structured exploit execution, ensuring organizations can proactively identify and mitigate emerging cybersecurity threats.

The Internet may serve as the entry point for external communication, connecting external clients, penetration testers, and security automation tools to the Secure testing network. Access to internal system components may be restricted through VPN authentication, firewall policies, and network segmentation mechanisms.

In some embodiments, the AI-driven cybersecurity platform may include:
AI-enhanced penetration testing modules, dynamically adjusting attack methodologies.
C2 communication layers, ensuring secure task distribution and exploit validation.
Load-balanced security execution, optimizing penetration test efficiency across distributed environments.

The system may continuously ingest security intelligence feeds, refining AI models based on attack simulations, adversarial threat analysis, and exploit chain modeling.

The Admin Group 304 may include high-level administrative users, who may be responsible for system configurations, security policy enforcement, and VPN infrastructure management. These users may have privileged access to configure Echidna-C2 308, ASM-C2 310, and Canima-AI 312, ensuring effective security orchestration and penetration test execution.

The Management Group 306 may consist of security analysts, penetration testing coordinators, and network administrators. This group may oversee security operations, manage job scheduling, and analyze vulnerability assessments generated by AI-driven security models.

The Secure testing network 305 may include multiple key security subsystems, each associated with a specific security function, including command-and-control (C2) operations, client environments, automated security jobs, manual testing environments, and security tooling.

The Echidna-C2 308 and ASM-C2 310 may serve as command-and-control (C2) infrastructures, facilitating real-time penetration testing, attack surface monitoring, and security automation workflows. These components may handle communication between security testing clients, network security scanners, and AI-driven security orchestration engines.

In some embodiments, the secure communication infrastructure may establish encrypted communication channels between security testing environments, client networks, and AI-driven security services.

The VPN architecture may implement:
Tailscale-based or other zero-trust security models.
End-to-end encryption for pentest execution logs and security telemetry.

In some embodiments, a Client-Deployed Open Virtual Appliance (OVA) may provide a self-contained execution environment for penetration testing. The OVA may be configured to:
Authenticate users through a secure AI-driven web service.
Execute penetration tests locally with preloaded tools (e.g., Metasploit, Burp Suite).
Ensure data isolation, preventing unauthorized network interactions.

In some embodiments, client-deployed virtual appliances may communicate with the platform infrastructure through a secure application programming interface (API) rather than maintaining persistent network connections to internal platform networks. The appliance may transmit testing telemetry, receive execution instructions, and exchange penetration testing data through authenticated API requests.

The communication interface may utilize token-based authentication mechanisms such as JSON Web Tokens (JWT) or OAuth-based authentication. Access to the API interface may be restricted using network allow lists or other access control mechanisms to ensure that only authorized testing appliances may communicate with the platform infrastructure.

This API-based communication architecture may reduce exposure of internal platform networks while allowing penetration testing appliances to securely exchange data and commands with the platform’s orchestration infrastructure.

The localized execution model may enhance compliance adherence while providing flexibility for AI-assisted penetration testing workflows.

Role-based network access control, ensuring only authorized entities communicate over the security infrastructure.

The system may utilize adaptive network routing, dynamically configuring secure channels for AI-assisted security testing workflows.

In some embodiments, Echidna (C2) may serve as the central command-and-control infrastructure, ensuring secure execution of penetration testing operations. The system may implement:
Encrypted C2 communication using Tailscale or other authentication for VPN-based access.
Remote command execution capabilities through API-based requests.
Rules of Engagement (ROE) enforcement, restricting execution to predefined network scopes.

The C2 system may also log all command executions, generating an immutable audit trail to maintain compliance with cybersecurity regulations.

Canima-AI 312 may serve as the primary AI-driven security analysis engine, leveraging machine learning models and reinforcement learning mechanisms to detect vulnerabilities, predict attack patterns, and optimize penetration testing strategies. Canima-AI 312 may interact with automated and manual security testing clients to analyze test results, refine threat detection models, and enhance overall security posture.

In some embodiments, an External Attack Surface Monitoring (ASM) system may be integrated to track network exposures and analyze potential vulnerabilities in real-time. The ASM module may utilize:
Nmap or similar asset discovery tools for external asset discovery and network topology mapping.
Shodan.io for detecting open ports and public services.
Credential exposure detection tools, which may utilize dark web intelligence feeds, breach notification services, or similar external data sources to track leaked credentials and compromised accounts
Vulnerability scanning and configuration assessment tools, which may include commercial or open-source vulnerability scanners, configuration analyzers, or proprietary security assessment frameworks.

The ASM system may proactively update security risk models based on real-time threat intelligence feeds, reducing the likelihood of undetected network misconfigurations.

The system may include client environments, categorized based on their security function:
ACP-Client 314, which may include Client-C and Client-D, may represent automated security clients designed to execute AI-driven penetration tests, vulnerability scans, and security policy audits.
ASM-Job, which may include Kali-1, Kali-2, and Kali-3, may serve as attack surface monitoring (ASM) job clients, responsible for active reconnaissance, open port scanning, and automated security testing.

In some embodiments, the system may implement an AI-driven penetration testing model based on AI security analysis engine, a fine-tuned version of a large language model (LLM)such as LLAMA 3.3 70B). AI security analysis engine may support:
Full fine tuning or LORA weight adaptation, optimizing AI decision-making for security use cases.
Data tokenization techniques, improving AI contextual understanding of network, cloud, and/or web vulnerabilities.

In some embodiments, the AI-driven security analysis engine may utilize a variety of machine learning model architectures. The platform may support integration of publicly available machine learning models, proprietary models, or combinations thereof. Model architectures may be replaced or updated over time as improved machine learning techniques become available. The system may therefore perform penetration testing analysis using different models without being limited to any particular machine learning architecture.

In some embodiments, the AI-driven security analysis engine may utilize a combination of machine learning models rather than a single fixed model architecture. The platform may integrate multiple models selected from publicly available or proprietary machine learning frameworks. These models may be updated or replaced over time as improved architectures become available. The system may therefore support continuous evolution of the AI infrastructure without dependency on a particular model implementation.

The AI infrastructure may support both fine-tuning of existing machine learning models and training of proprietary models using internally generated security datasets. These datasets may include exploit simulations, penetration testing results, vulnerability telemetry, and security intelligence feeds. By supporting both fine-tuning and custom model training workflows, the system may continuously improve penetration testing performance while remaining adaptable to new model architectures and evolving threat landscapes.

In some embodiments, a C2 infrastructure may orchestrate penetration testing workflows and security intelligence processing. The AI-driven C2 model may include:
Automated Task Scheduling: Assigning test execution phases based on AI-defined priorities.
Adaptive Attack Strategies: Refining penetration testing parameters dynamically based on AI-generated insights.
Security Logging and Compliance: Capturing all C2 interactions for audit and regulatory compliance.

The C2 scheduler may analyze past penetration test performance and refine attack techniques in real-time based on the latest threat intelligence.

In some embodiments, the platform may maintain a project-specific graph database that stores structured security intelligence associated with each penetration testing engagement. The graph database may represent relationships between discovered hosts, network services, vulnerabilities, credentials, and exploit paths. Each node within the graph may represent a discovered asset or security artifact, while relationships between nodes may represent logical connections such as network reachability, credential reuse, privilege escalation paths, or vulnerability chains.

The graph database may enforce strict project-level data isolation. Each client engagement may be assigned a dedicated graph structure, ensuring that security data from one engagement cannot be accessed by AI agents assigned to another engagement. This separation may prevent cross-client data contamination and ensure that AI agents operate only on data associated with the assigned penetration testing project.

In some embodiments, each node within the graph database may be associated with a primary engagement target, such as a domain name, application identifier, or network address range. All relationships within the graph may be linked to this root entity to ensure that all discovered data can be traced back to the originating target system. This structure may prevent orphaned data nodes and maintain clear traceability between reconnaissance results, vulnerability analysis, and exploit simulations.

Reinforcement Learning with Human Feedback (RLHF), refining penetration test execution strategies based on prior attack success rates.

The AI model may dynamically adjust penetration testing methodologies based on evolving threat intelligence feeds, attack trend analysis, and adversarial behavior prediction.

The Echidna-Job Scheduler 322, which may include Scheduler-1, Scheduler-2, and Scheduler-3, may manage automated job execution within the Secure testing network 305. This component may coordinate penetration testing tasks, schedule attack surface monitoring (ASM) workflows, and ensure optimal utilization of security testing resources.

The Echidna-LoadBalancer 324 may distribute security testing workloads across multiple C2 environments, automated penetration testing clients, and AI-driven security analysis engines. Load balancing may ensure scalability, fault tolerance, and efficient resource allocation for high-demand penetration testing and attack surface management operations.

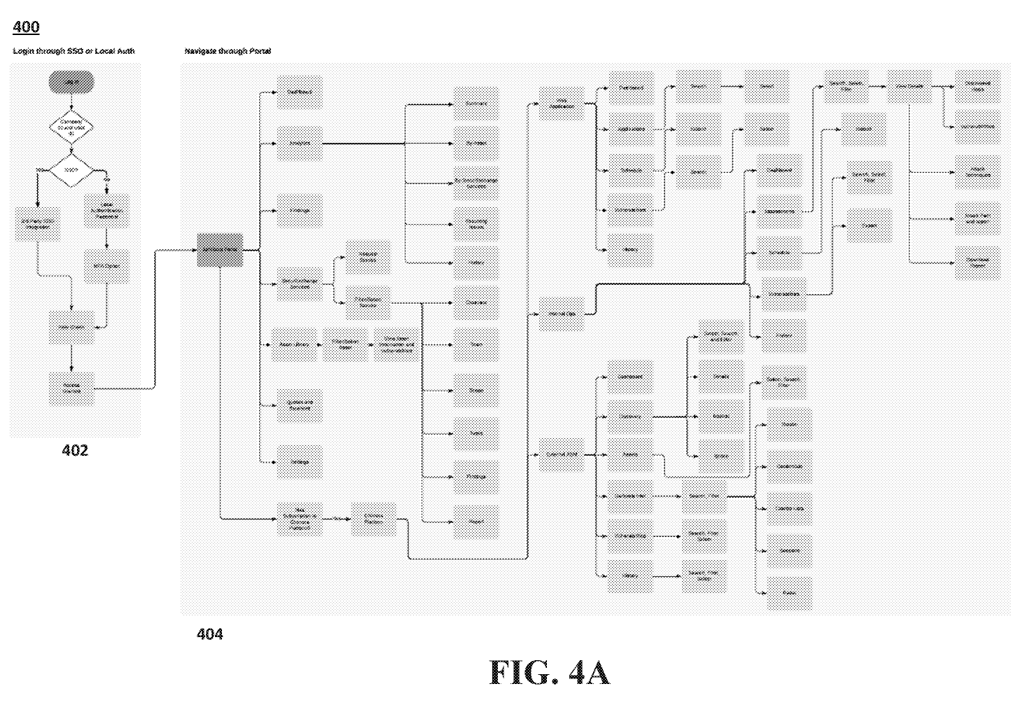

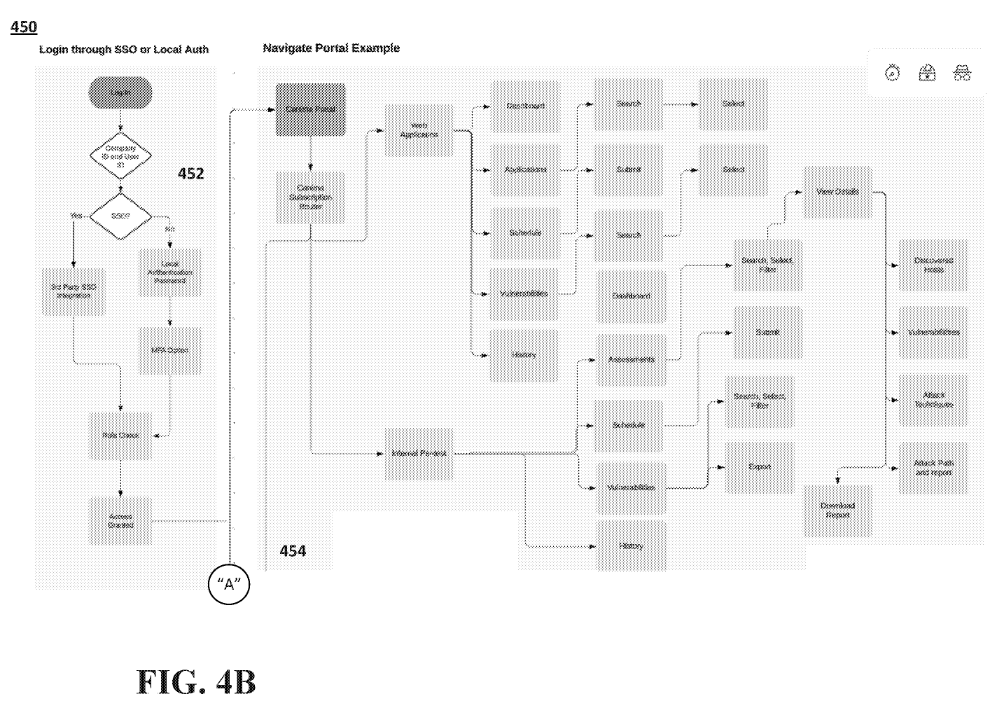

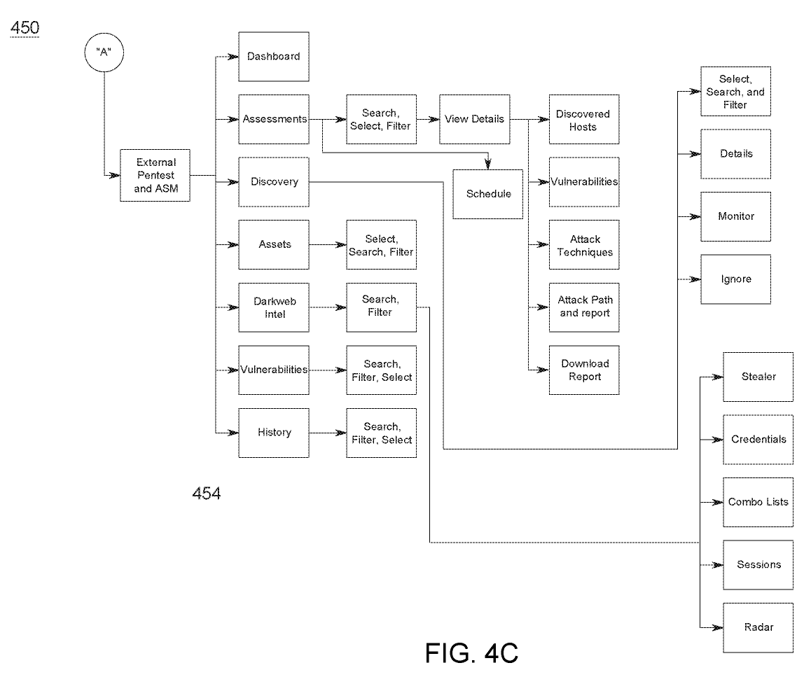

FIGS. 4A-4C are diagrams illustrating examples of the Canima customer journey 400, 450 depicting the user authentication process, dashboard navigation, role-based access control, asset management, vulnerability tracking, and security analysis features. FIG. 4A illustrates the Canima Customer Journey, which may define the user authentication process, role-based access control, dashboard navigation, security assessments, and service interactions within the Canima platform. The system may allow users to log in, access assets, request security services, monitor vulnerabilities, and generate reports based on security findings.

A user may begin their journey by logging in through either Single Sign-On (SSO) or Local Authentication 402. If SSO is used, authentication may be managed via a third-party identity provider. If local authentication is selected, the user may enter their Company ID and User ID along with a password to gain access.

After login, a Multi-Factor Authentication (MFA) check may be presented as an additional security layer. If MFA is required, the user may be prompted to complete authentication before proceeding. Upon successful authentication, the system may perform a Role Check to determine the user’s permissions and access level. If access is granted, the user may be directed to the Security management portal, where the primary interface and service functionalities are available within the portal navigation workflow 404.

In some embodiments, the portal navigation workflow 404 may include operational controls that allow users to initiate and manage security assessments across selected computing assets. Through the portal interface, a user may select a target asset, identify an appropriate security service, and initiate testing operations. For example, a user may select services including vulnerability scanning, penetration testing, attack surface monitoring, or web application testing. The portal interface may provide controls that allow a user to initiate actions such as start scan, start penetration test, start attack surface monitoring, or start web testing, which may trigger corresponding automated security tasks within the platform infrastructure.

In some embodiments, the portal workflow 404 may include an Active Penetration Validation Testing (Active PVT) process that coordinates execution of automated penetration testing activities. The Active PVT process may manage communication between the user portal and the underlying penetration testing infrastructure, enabling tests to be launched, monitored, and controlled from the portal interface. The Active PVT process may further coordinate selection of testing tools, allocation of computational resources, and execution of security probes against selected target systems.

The portal interface may further provide asset management and vulnerability review capabilities. In some embodiments, users may select assets from an asset library, view asset information, and analyze security findings associated with those assets. The system may present information related to detected hosts, discovered services, and identified vulnerabilities. Users may navigate between discovery results, asset details, vulnerability listings, and historical scan results through the portal interface. In this manner, the platform may provide a consolidated view of security posture across monitored systems.

In some embodiments, additional security intelligence features may be available through the portal interface. For example, credential monitoring tools may analyze compromised credential sources and track suspicious account activity. The system may monitor credential exposures, maintain lists of compromised credentials or credential combinations, and provide monitoring of authentication sessions associated with potential security risks. The portal may also provide visualization tools that display attack techniques, attack paths, and associated vulnerabilities identified during penetration testing simulations.

In some embodiments, the platform may generate reports and security documentation based on detected vulnerabilities and penetration testing results. Users may view vulnerability summaries, review attack techniques used during simulated penetration testing, and analyze attack paths associated with detected weaknesses. The portal interface may further allow users to generate and download reports summarizing detected hosts, vulnerabilities, attack paths, and remediation recommendations for selected assets.

In some embodiments, a structured customer journey may be implemented to streamline user interactions with the penetration testing platform. A multi-step authentication process may be required, incorporating Single Sign-On (SSO) or local authentication, followed by a multi-factor authentication (MFA) verification. Once logged in, users may be guided through a role-based access control (RBAC) system that dictates available security assessments and system permissions.

The customer dashboard may serve as the primary interface for managing security assessments, vulnerability tracking, automated penetration test scheduling, and risk mitigation actions. If a user requests a pentest, the system may verify their subscription status, authorize the request through the Security management portal API, and automatically queue the test for execution via the command-and-control (C2) infrastructure.

If vulnerabilities are identified, the system may provide automated security recommendations via the Findings module, where users may review reports, initiate follow-up scans, and receive real-time threat intelligence alerts.

Within the Security management portal, users may navigate through various dashboard features based on their role and subscription level. These may include:
Analytics, which may provide security data visualizations, system performance metrics, and penetration test results.
Findings, which may summarize identified vulnerabilities, security alerts, and risk assessments.
SecurExchange Services, which may provide security-related transaction records, service subscriptions, and security request history.
Asset Library, which may enable users to search, filter, and select security assets for monitoring and vulnerability analysis.
Quotes and Balances, which may display service pricing details and billing records.
Settings, which may allow users to customize their security policies, notification preferences, and role-based permissions.

If the user selects Findings, they may navigate through a detailed security assessment workflow, which may be structured by SecurExchange Services or organized By-Asset. Findings may be categorized based on:
Recurring Issues, which may identify vulnerabilities detected multiple times.
History, which may provide past security reports and risk mitigation actions. ° Request Service, which may enable users to initiate a security assessment or penetration test.

Users may filter and select assets from the Asset Library, which may provide an overview of security risks, threat levels, and vulnerability scores for specific assets. If a user has an active subscription to the Canima Platform, they may be granted access to advanced security services and vulnerability assessments.

If subscribed, the user may navigate to Canima Platform, where they may access:
External Attack Surface Monitoring (ASM), which may analyze security vulnerabilities in public-facing assets.
Internal Operations Security, which may monitor private infrastructure vulnerabilities.
Web Application Testing, which may assess security weaknesses in deployed web services.

Dark Web Intelligence, which may track leaked credentials, compromised assets, and threat actor activity.

Users may view vulnerabilities detected in different security assessments, including:
Discovery, which may present an initial security scan of exposed services.
Dashboard, which may summarize security findings and mitigation recommendations.
History, which may store past vulnerability scans and resolved security alerts.

If vulnerabilities are detected, users may take actions such as:
Monitor, which may track vulnerabilities over time.
Ignore, which may allow users to dismiss false positives or low-priority issues.

For credential security, the Stealer Credential Monitoring module may allow users to track compromised credentials, monitor combo lists, and review sessions for suspicious logins. The Radar tool may provide real-time tracking of compromised credentials and attack simulations.

Users may export reports, which may include:

In some embodiments, a Client-Deployed Open Virtual Appliance (OVA) may be utilized to provide a self-contained execution environment for penetration testing. The OVA may be configured to:
Authenticate users via a secure web service linked to the AI security analysis engine platform.
Preload penetration testing tools such as Metasploit, Burp Suite, and Nmap.
Implement directional communication enforcement, restricting unauthorized lateral movement within a network.
Enable automated incremental backups, preserving execution logs and attack simulations for post-assessment review.

This localized execution model may enhance network segmentation, data privacy, and compliance adherence while maintaining the flexibility of AI-assisted penetration testing workflows.

Discovered Hosts, listing all detected networked systems.

Vulnerabilities, outlining security risks per asset.

Attack Techniques, categorizing methods used in simulated penetration tests.

Attack Path and Report, visualizing the steps used to exploit vulnerabilities.

Download Report, enabling users to generate security compliance reports.

The Canima Customer Journey may streamline user interactions within the Canima security ecosystem, ensuring a structured workflow for authentication, security assessments, monitoring, and vulnerability management.

FIG. 4B illustrates an example portal navigation and user interaction workflow 450 for accessing and interacting with the automated penetration testing and attack surface management platform. The workflow 450 represents the sequence of authentication operations and the navigation structure of the platform portal through which users may access security testing services, vulnerability information, and related analytics.

In some embodiments, a user may begin the interaction by accessing the platform through a login interface. As shown in FIG. 4B, the login portion of the workflow may include a login through single sign-on (SSO) or local authentication process 452. The login process may allow a user to authenticate using an external identity provider or through locally stored credentials. For example, the login process may present a decision step determining whether single sign-on authentication is available. If SSO authentication is used, the system may redirect the user to an identity provider to complete authentication. Alternatively, the user may provide local credentials such as a username and password. In some embodiments, the login process may include additional authentication steps such as multi-factor authentication (MFA), which may require verification through a secondary device or authentication application before access is granted.

Upon successful authentication, the user may be granted access to the platform portal environment represented by portal navigation structure 454. The portal may provide a centralized user interface through which users can manage security testing engagements and view security intelligence generated by the platform.

In some embodiments, the portal may include a dashboard interface, which may present a summary view of security posture information for the user's projects. The dashboard may display information such as overall security status, recent vulnerability findings, assessment results, and activity summaries. The dashboard may also provide navigation links to other platform modules.

The portal may provide access to an analytics module, which may present detailed data visualizations and metrics relating to security assessments. The analytics module may allow users to review historical assessment data, vulnerability trends, testing coverage metrics, and other analytical information derived from penetration testing activities.

In some embodiments, the portal may also include an assets module, which may allow users to view and manage assets associated with a testing engagement. Assets may include domains, subdomains, hosts, services, applications, and other infrastructure components discovered or registered for testing. The assets module may allow filtering, searching, and categorization of discovered assets.

The portal navigation may further include a vulnerabilities module, which may present detailed information about security vulnerabilities identified during testing operations. The vulnerabilities module may allow users to review vulnerability descriptions, severity ratings, affected assets, remediation recommendations, and related vulnerability intelligence. Users may be able to filter vulnerabilities by severity, asset type, or testing phase.

In some embodiments, the portal may include a history module, which may provide access to historical testing results, previously discovered vulnerabilities, and archived security reports. This module may allow users to review past testing engagements and track remediation progress over time.

The portal may also include functionality for initiating and managing security assessments. For example, users may be able to start new security assessments, schedule recurring testing operations, or review the progress of active testing campaigns. The portal may provide controls for initiating penetration testing workflows, configuring testing parameters, or managing testing schedules.

In some embodiments, the portal may include a request services interface, which may allow users to request additional security services or testing operations. These services may include vulnerability scanning, web application testing, external attack surface monitoring, internal network testing, or specialized security analysis services.

The portal navigation may also include modules for managing reporting and output data. For example, users may be able to generate security reports, download vulnerability summaries, or export assessment results for compliance or auditing purposes.

The portal may also provide administrative functions that allow authorized users to manage account settings, configure notification preferences, manage user roles, and update project configurations.

Through the portal navigation structure 454 illustrated in FIG. 4B, the system may provide an integrated interface for managing security assessments, reviewing vulnerability findings, and coordinating automated penetration testing operations across multiple client environments.

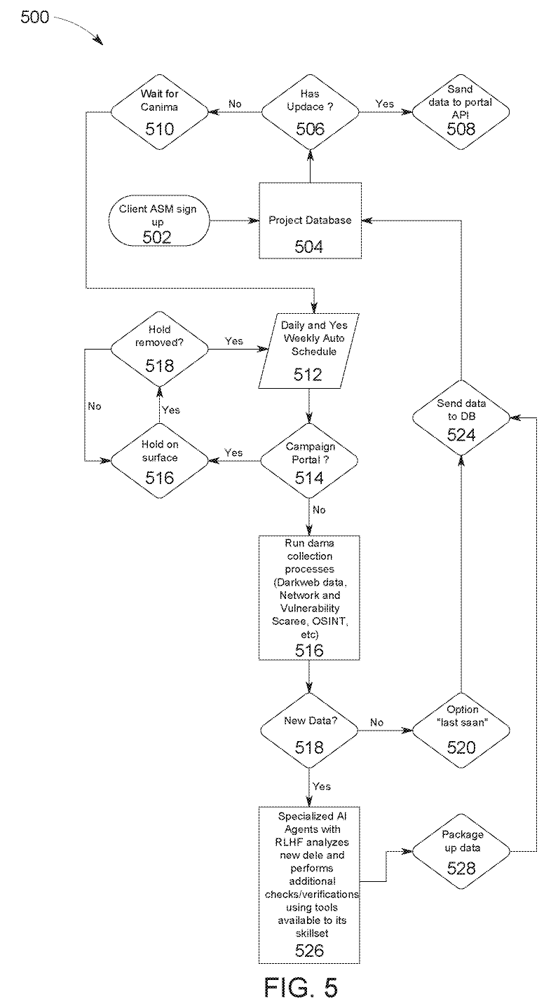

FIG. 5 is a flowchart illustrating the external attack surface monitoring (ASM) workflow, detailing the process for detecting security vulnerabilities through automated data collection, AI-based threat analysis, and reporting mechanisms. FIG. 5 illustrates External Attack Surface Monitoring (ASM) 500, which may facilitate the automated collection, analysis, and reporting of security vulnerabilities using external scanning techniques and AI-driven insights. The process may involve scheduled scanning, data aggregation, AI-enhanced risk assessment, and integration with external command-and-control (C2) infrastructures.

The process may begin with Client ASM sign-up 502, where a client may enroll in external attack surface monitoring services. Upon successful enrollment, the system may establish an automated security monitoring process through project database 504, which may serve as the command-and-control system responsible for scheduling, executing, and managing external security scans. At 506, a determination may be made as to whether an update is available. For example, when new updates are available, the system may proceed to send data to portal API 508, where the latest security insights may be made accessible to authorized users through a dedicated security portal. When no updates are detected, the system may enter a waiting phase in Wait for Update 510, continuously monitoring for changes in attack surface data.

In some embodiments, an ASM may automate the discovery and continuous monitoring of external attack surfaces. The system may implement:
Continuous scanning of publicly accessible assets.
Dark web intelligence integration for credential leakage monitoring.
Automated threat correlation, identifying attack vectors before exploitation.

The ASM module may automatically schedule external security scans at predefined intervals, ensuring that emerging risks are detected in real time. Data may be processed through Canima, which may refine risk classification methodologies based on historical attack trends.

In some embodiments, an External Attack Surface Monitoring (ASM) system may be integrated to track and analyze security vulnerabilities in real-time. The ASM module may utilize:
Asset discovery and external network mapping tools, such as Nmap, runZero, or similar utilities.
Shodan.io for identifying publicly exposed services.
Vulnerability scanning and misconfiguration detection tools, which may include, but are not limited to, commercial vulnerability scanners and open-source assessment frameworks.
Credential leakage and compromised account detection services, which may incorporate dark web monitoring, breach notification services, or proprietary intelligence feeds.

The system may automatically schedule periodic attack surface scans and may update its findings continuously, integrating real-time CVE alerts into its risk assessment model.

A Weekly Auto Schedule 512 may be implemented, allowing the system to execute routine attack surface monitoring at predefined intervals. When the monitoring campaign is paused 514, the system may temporarily halt scanning activities. When the campaign is paused, the system may hold on scans 516 and check whether the hold has been removed 518. When the hold is lifted, the monitoring workflow may resume by proceeding to the next phase of data collection. When the hold remains active, scanning activities may continue to be suspended.

When the monitoring campaign is active, the system may initiate Run Data Collection Processes 516, which may aggregate security intelligence from various sources, including Dark Web Data, Network Scans, and Vulnerability Scans. These processes may provide comprehensive security assessments by identifying exposed assets, misconfigurations, and potential threat indicators.

When there is not new data (at 518), the system may proceed to update “Last Seen” 520, which may track the most recent activity for each scanned entity. At 524, send data to the project database 504.

When new data is detected (at 518), the system may transmit it to Canima to enhance security threat detection and vulnerability assessments. The collected security data may be processed and analyzed by specialized AI agents 526 before being transmitted to the command-and-control system. Once the data has been packaged, the data may be sent to the project database 504 where security intelligence may be analyzed and stored for further evaluation.

The figure illustrates an example external attack surface monitoring workflow 500 used by the penetration testing platform to continuously collect, analyze, and submit security intelligence related to external network infrastructure.

In some embodiments, the workflow may begin with a project database 524, which may store information associated with a client project, including target domains, network ranges, configuration parameters, and testing schedules. A client ASM sign-up process 526 may allow a client or administrator to register a target environment for monitoring. The registration information may be stored within the project database 504.

The platform may periodically check whether updated monitoring operations should be executed. For example, a has update decision stage 502 may determine whether updated data should be transmitted to a platform API. If an update is required, the system may perform a data submission operation 504, which sends collected monitoring data to the platform interface. If no update is required, the system may enter a wait state 506 until the next monitoring interval.

In some embodiments, a daily and weekly automated scheduler 508 may control when external attack surface monitoring operations are executed. The scheduler 508 may evaluate conditions such as campaign paused status 510, hold on scans state 512, or host removal conditions 514 that may temporarily suspend scanning activities. When scanning is permitted, the scheduler 508 may initiate automated data collection processes.

The platform may then execute a data collection stage 516, which may perform reconnaissance and vulnerability enumeration operations. These operations may include processes such as domain enumeration, network scanning, attack surface monitoring (ASM), open-source intelligence (OSINT) analysis, vulnerability detection, and related data collection tasks.

Following data collection, the system may determine whether new data has been discovered 518. If new information has been identified, the system may determine whether updated testing operations should be initiated, such as through an update test server decision stage 520. If updates are required, the system may transmit the collected data through a data submission operation 522, which may send monitoring results to the platform or testing infrastructure.

In some embodiments, collected data may also be processed by specialized artificial intelligence analysis components 526, which may apply machine learning techniques such as reinforcement learning from human feedback (RLHF), anomaly detection, vulnerability classification, or attack path analysis. The AI analysis components may enrich collected monitoring data and produce security intelligence used by automated penetration testing agents.

Processed results may then be packaged into data structures 530 suitable for transmission or storage. The packaged data may be submitted to platform services, testing infrastructure, or security dashboards where the information may be used to trigger additional testing activities, update project knowledge graphs, or generate security findings.

Through this automated monitoring workflow, the platform may continuously track changes in external attack surfaces, detect newly exposed services or vulnerabilities, and update penetration testing intelligence in near real time.

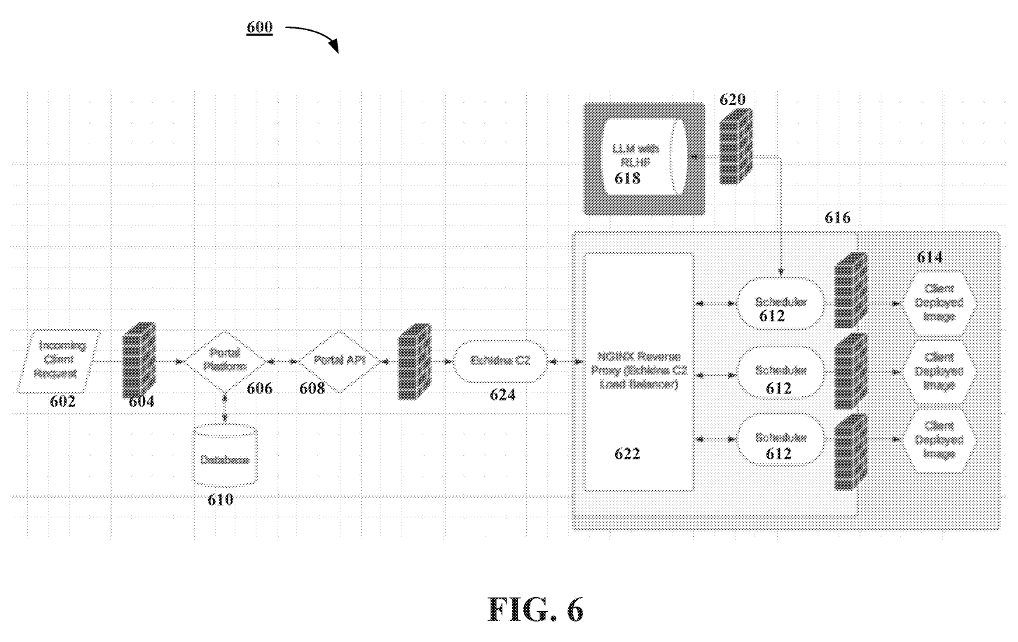

FIG. 6 is a flowchart illustrating the high-level C2 penetration testing flow, demonstrating how penetration testing requests are processed, executed, and analyzed using AI-driven decision-making models and load-balanced C2 operations. FIG. 6 illustrates the High-Level C2 Pentest Flow 600, which may represent the process flow for conducting AI-driven penetration testing operations within a command-and-control (C2) environment. The system may integrate multiple components, including a scheduling mechanism, AI-assisted security analysis, penetration testing infrastructure, and load balancing functionalities to ensure efficient and scalable security assessments.

The process may begin with an Incoming Client Request 602, where a client may submit a security testing request through a firewall 604 to the Portal API 606. This API may act as a communication interface, allowing external clients to interact with the penetration testing infrastructure.

In some embodiments, C2 controller may serve as the primary command-and-control infrastructure for coordinating penetration test execution, managing AI-driven threat analysis, and dynamically adjusting security attack models.

The penetration testing workflow may involve:
Client Canima Request: Customers may submit pentest requests through the Canima API.
C2 Scheduler: The system may queue, load balance, and prioritize penetration test tasks.
Execution of Exploit Scripts: AI may direct the execution of reconnaissance, vulnerability exploitation, and post-exploitation validation.
C2-AI Interaction: AI may provide feedback loops to refine security test parameters dynamically.

The C2 platform may maintain detailed audit logs, tracking pentest execution in real time and ensuring compliance with security testing regulations.

In some embodiments, the automated pentest scheduling module may operate as follows:
Customer initiates a pentest request via the Security management portal.
The system’s API communicates with the C2 scheduler, verifying parameters such as network scope, compliance restrictions, and scheduling preferences.
C2 dynamically schedules and executes penetration test scripts.
AI analyzes test results at each stage and provides real-time feedback to improve the test execution model.

The AI Updater continuously fine-tunes penetration testing strategies based on evolving threat intelligence.

The pentest automation module may enable seamless integration with CI/CD security pipelines, allowing enterprises to automatically execute security assessments during software development lifecycles.

In some embodiments, a C2 Scheduler may be implemented to manage penetration testing execution in structured phases. The automated workflow may be structured as follows:
Reconnaissance Phase: Executes tools such as Nmap, nmapautomator, or other open source reconnaissance tools to scan network assets.
Vulnerability Analysis Phase: Calls external vulnerability assessment APIs (e.g., Nessus).
Exploitation Phase: Uses CVE databases, exploit repositories, and AI-assisted decision-making to simulate real-world attack scenarios.
Report Generation Phase: Uses AI-based analytics to generate attack narratives, categorize risks, and recommend mitigation actions.

Each phase may be orchestrated by AI security analysis engine, dynamically adapting attack techniques based on evolving security intelligence.

The Portal 608 may serve as the centralized user interface for managing penetration test requests, reviewing test results, and configuring security assessment parameters. The Portal Platform 606 may process incoming penetration testing tasks and coordinate execution through the Scheduler 612. The Database 610 may store historical penetration test results, security logs, and AI-generated insights, enabling future analysis and pattern-based security enhancement strategies.

The Scheduler 612 may be responsible for assigning penetration test jobs to the appropriate Client Deployed Image 614 instances, e.g., through firewalls 616. These deployed images may be virtualized security environments configured for AI-assisted penetration testing operations.

In some embodiments, penetration testing tasks may be coordinated using a distributed job queue system. The job queue may store pending penetration testing projects and task execution instructions within a centralized datastore. Worker processes may retrieve available tasks from the queue, claim ownership of a project, and execute penetration testing operations associated with that project.

Each worker process may register ownership of an assigned project within the job queue system. While executing tasks, the worker may periodically update job status indicators. If a worker process becomes unavailable or fails to complete assigned tasks within a defined time interval, the system may release the job back to the queue, allowing another worker process to resume execution.

This distributed worker architecture may provide fault tolerance and automatic failover capabilities. By enabling multiple workers to retrieve and execute tasks from a centralized job queue, the system may maintain high availability and ensure that penetration testing operations continue even if individual workers become unavailable.

The system may leverage LLM with RLHF 618 (also known as Canima), which may be an AI model utilizing reinforcement learning from human feedback (RLHF) to optimize penetration test execution, refine exploit strategies, and enhance security vulnerability detection. Which may be connected to the scheduler 612 through firewall 620.

To ensure scalable and balanced request distribution, the system may employ NGINX Reverse Proxy (C2 controller Load Balancer) 622, which may manage network traffic distribution across multiple penetration testing environments. This load balancer may ensure that pentest requests are evenly distributed to avoid overloading any single testing instance.

The Client Deployed Image 614 instances may execute automated penetration tests, vulnerability assessments, and attack simulations, interfacing with the C2 controller 624 infrastructure for command-and-control (C2) operations.

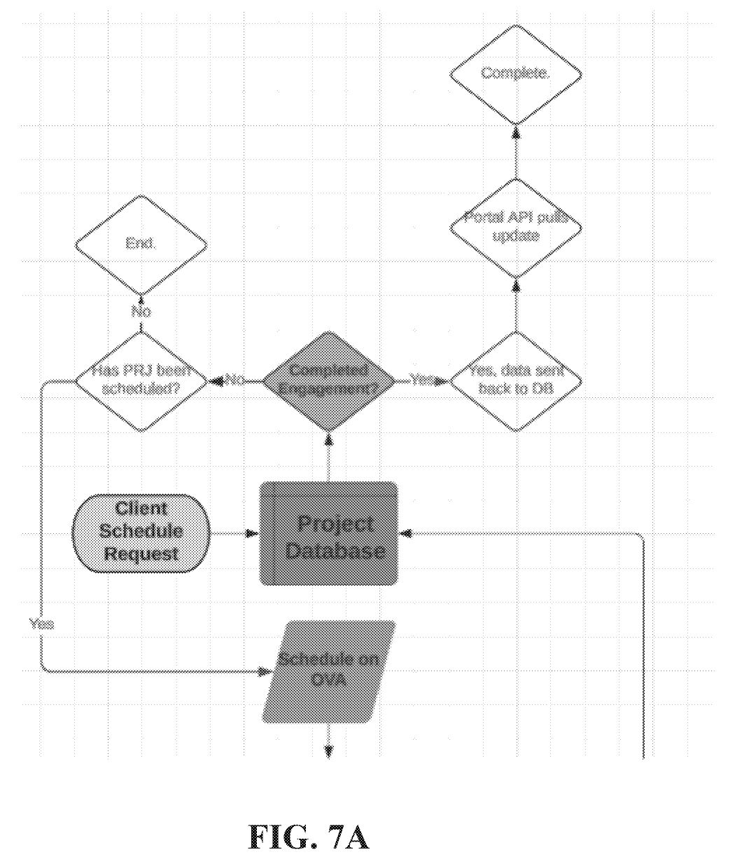

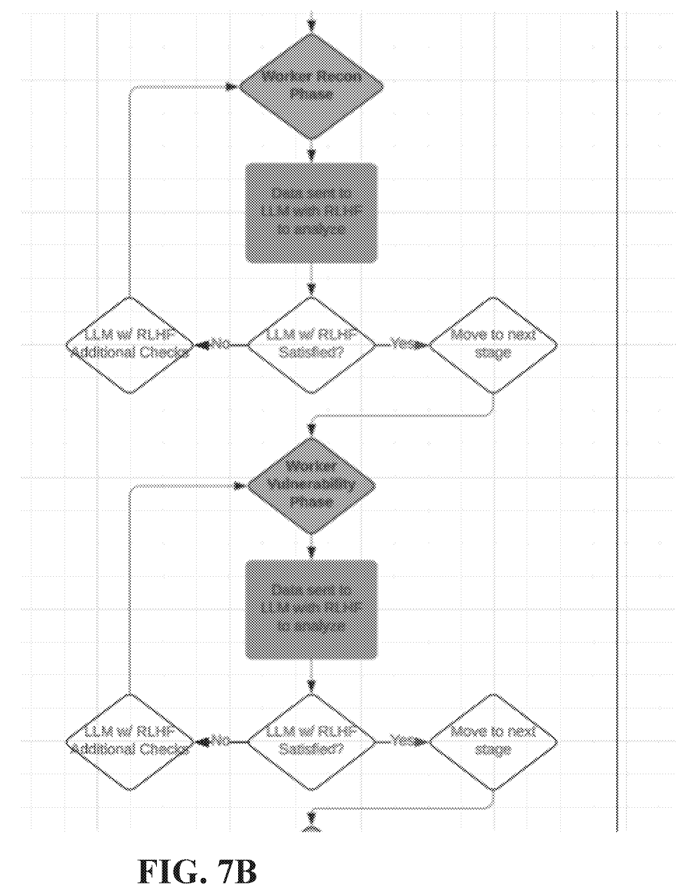

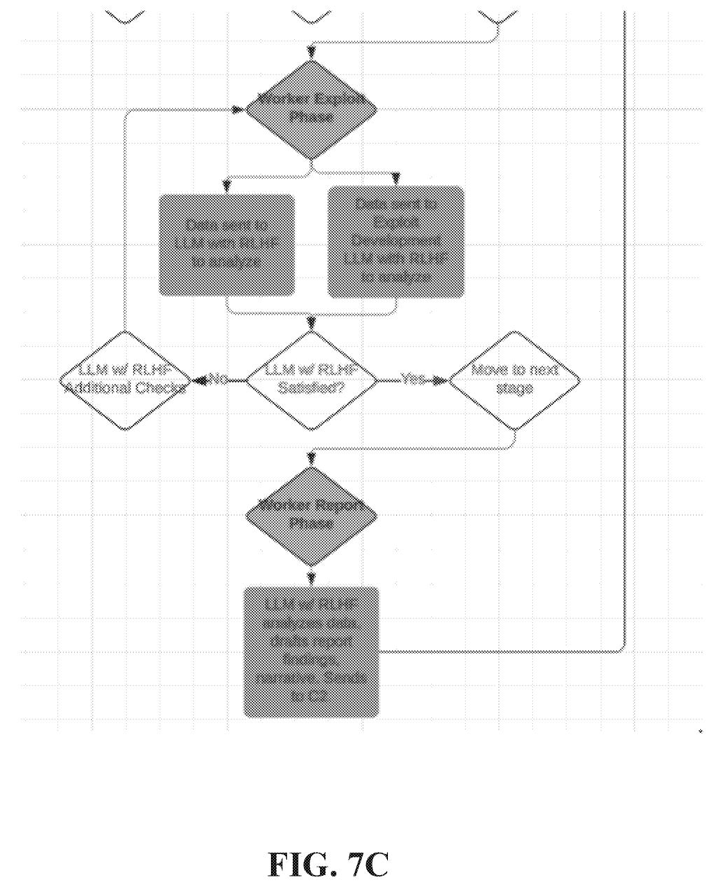

FIGS. 7A-7C are a flowchart illustrating the internal network request workflow, outlining the sequence of reconnaissance, vulnerability assessment, exploitation, and reporting phases in AI-assisted penetration testing. FIGS. 7A-7C illustrates the Internal Network Request Flow, which may define the structured process for executing penetration testing within an internal network environment using AI-driven analysis and command-and-control (C2) orchestration. The system may incorporate automated reconnaissance, vulnerability assessment, exploitation, and reporting stages, each integrating with Canima to enhance penetration testing accuracy and decision-making.

The process may begin with Canima Request, where a security testing request may be initiated within the internal network. Once the request is received, the system may initiate Schedule on OVA, which may allocate a virtualized testing environment for executing security operations.

The system may enter the Recon Phase, during which network reconnaissance activities may be conducted to identify live hosts, open ports, services, and initial security risks. The reconnaissance data may then be sent to Canima, which may analyze the collected information and determine whether the reconnaissance phase is satisfactory.

If the LLM with RLHF determines the reconnaissance phase is satisfied, the process may proceed to the next phase. Otherwise, Canima Additional Checks may be performed to refine data collection and improve reconnaissance accuracy before reassessment.

Following reconnaissance, the system may enter the Vulnerability Phase, where identified network assets may be evaluated for known vulnerabilities, misconfigurations, and potential attack vectors. The collected vulnerability data may then be sent to Canima for analysis.

If the LLM with RLHF determines that the vulnerability assessment is satisfactory, the process may proceed to the next stage. If additional analysis is required, the system may trigger LLM with RLHF Additional Checks to refine vulnerability detection before reevaluation.

The system may then transition to the Exploit Phase, where identified vulnerabilities may be exploited in a controlled manner to validate security risks. The results from the exploitation attempts may be sent to LLM with RLHF for evaluation.

If the LLM with RLHF determines the exploit phase is satisfactory, the process may move to the next stage. If not, LLM with RLHF Additional Checks may be conducted to enhance exploit execution and effectiveness.

The Report Phase may be initiated upon completion of exploitation activities. During this phase, LLM with RLHF may analyze test data, generate structured vulnerability reports, provide a security risk narrative, and compile remediation recommendations. The generated report may then be sent to Internal C2 for centralized processing and review.

If the engagement is marked as completed, the system may finalize security assessment operations, ensuring all relevant test data is captured. If the engagement is not yet completed, the system may determine whether a project (PRJ) has been scheduled.

If a project has been scheduled, the system may process the Client Schedule Request 748 to ensure proper coordination of future penetration tests. If no project has been scheduled, the process may terminate.

After finalizing all penetration testing steps, the system may send data to Portal API 750, ensuring that findings and security reports are available for authorized users through the client interface. The system may then be marked as complete, finalizing all penetration testing tasks.

In some embodiments, additional exploit development may be performed, where data is sent to Exploit Development LLM with RLHF for refining exploit techniques and attack simulation strategies.

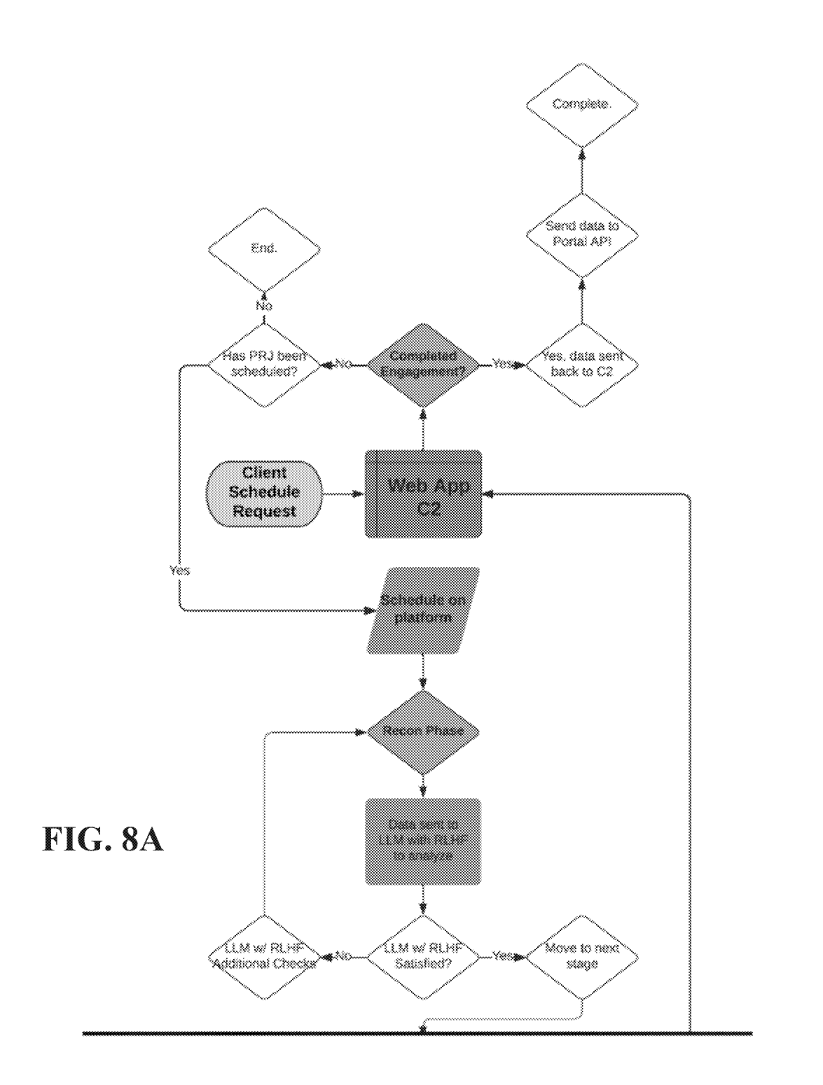

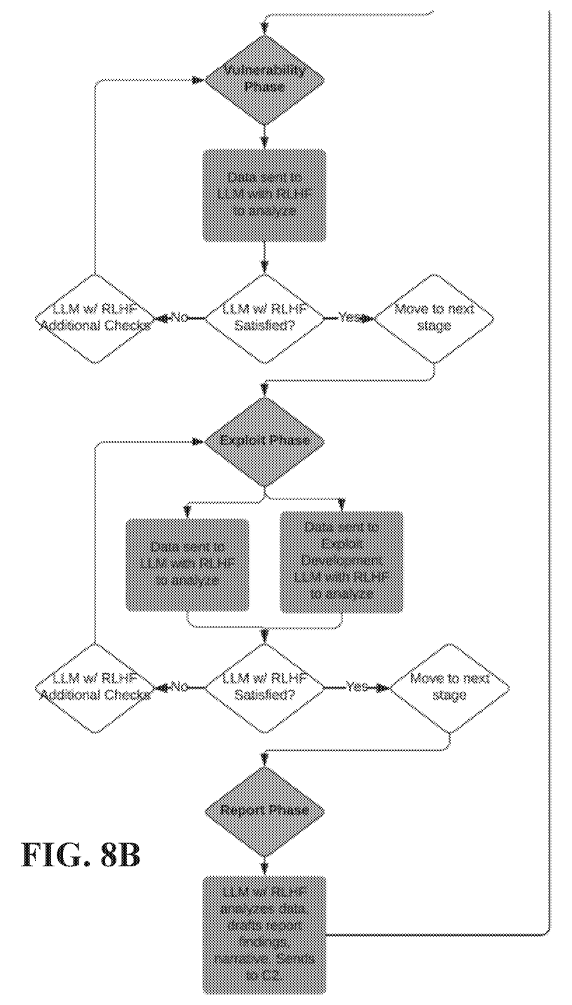

FIGS. 8A-8B are a flowchart illustrating the web application testing workflow, showing how AI-driven security assessments analyze web application vulnerabilities, perform exploit simulations, and generate structured security reports. FIGS. 8A-8B illustrate the Web Application Testing Canima Request Flow, which may define the structured process for conducting AI-driven security testing on web applications. The system may integrate automated reconnaissance, vulnerability scanning, controlled exploitation, and AI-driven reporting, ensuring thorough and adaptive web security assessments.

In some embodiments, the Web App C2 framework may facilitate AI-driven web application penetration testing, analyzing API vulnerabilities, authentication bypass methods, injection attack vectors, and session hijacking techniques. The system may schedule web security tests dynamically, allowing users to configure scan intensity levels based on risk profiles, regulatory compliance, and predefined security policies.

The AI-driven security assessment engine may adapt to different web architectures, including cloud-native applications, microservices-based APIs, and containerized web platforms. The reconnaissance phase may analyze:
Publicly accessible endpoints, mapping exposed services.
User authentication flows, identifying weak session management techniques
Injection vulnerabilities, scanning for SQL, XSS, and XML-based attack vectors.

If an exploit attempt is successful, the system may automatically categorize the impact level, determine mitigation strategies, and prioritize response actions.

The process may begin with Schedule on Platform, where a web application security test may be scheduled for execution within the Canima testing framework. Once the test is scheduled, the system may proceed to the Recon Phase, during which web-based reconnaissance techniques may be employed to gather data on the target application.

The reconnaissance data may then be sent to Canima, which may analyze the collected information to determine whether the reconnaissance phase has yielded sufficient intelligence for vulnerability analysis.

If LLM with RLHF determines that the reconnaissance phase is satisfactory, the process may proceed to the next phase. Otherwise, LLM with RLHF Additional Checks may be performed to refine reconnaissance data collection and improve accuracy before reevaluation.

The system may then transition to the Vulnerability Phase, where the web application may be scanned for known security vulnerabilities, misconfigurations, and other weaknesses. The vulnerability data may then be sent to LLM with RLHF for analysis.

If LLM with RLHF determines that the vulnerability assessment is satisfactory, the process may proceed to the next stage. If additional validation is required, the system may execute LLM with RLHF Additional Checks to refine vulnerability detection before proceeding.

The system may then enter the Exploit Phase, where identified vulnerabilities may be exploited in a controlled manner to assess their severity and validate security risks. The results from the exploitation attempts may be sent to LLM with RLHF for analysis.

If LLM with RLHF determines that the exploit phase is satisfactory, the process may proceed to the next stage. If additional refinements are necessary, LLM with RLHF Additional Checks may be conducted to improve exploit effectiveness.

Once exploitation is complete, the system may initiate the Report Phase, where LLM with RLHF may analyze the security test data, generate a structured vulnerability report, provide a security risk narrative, and compile remediation recommendations. The generated report may then be sent to Web App C2 for centralized processing and review.

If the engagement is marked as completed, the system may finalize security assessment operations and transmit findings for further processing. If the engagement is not yet completed, the system may determine whether a project (PRJ) has been scheduled.

If a project has been scheduled, the system may process the Client Schedule Request to ensure proper coordination of future web application security tests. If no project has been scheduled, the process may terminate.

After finalizing all penetration testing steps, the system may send data to Portal API, ensuring that findings and security reports are available for authorized users through the client interface. The system may then be marked as complete, finalizing all penetration testing tasks.

In some embodiments, additional exploit development may be performed, where data is sent to Exploit Development LLM with RLHF for refining exploit techniques and attack simulation strategies.

The described embodiments provide AI-driven security assessment systems and methods for conducting automated penetration testing, attack surface monitoring, and vulnerability analysis using command-and-control (C2) infrastructures, machine learning models, and reinforcement learning from human feedback (RLHF). These embodiments may enhance cybersecurity operations by integrating AI-based decision-making, automated exploit validation, and scalable security test orchestration.

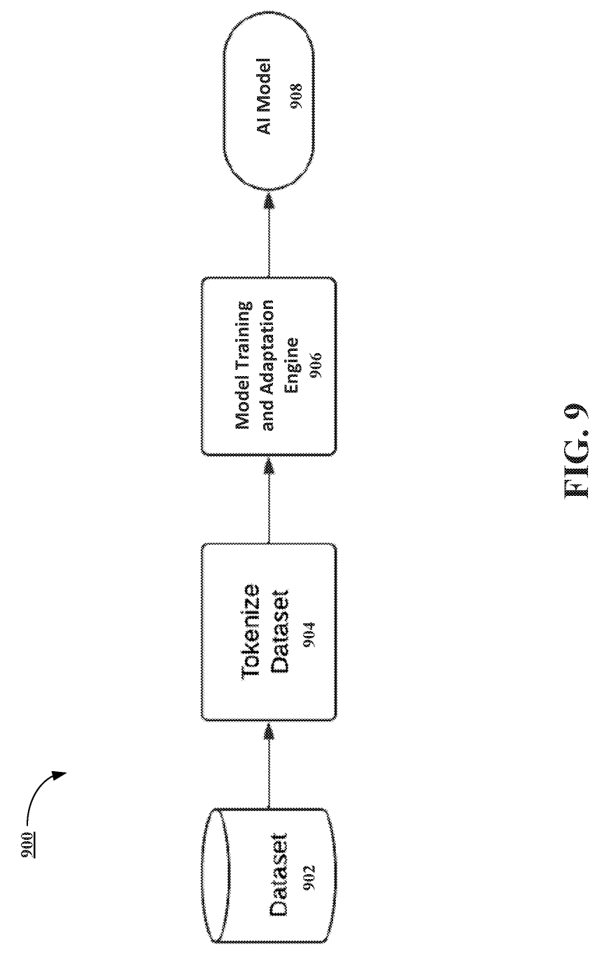

FIG. 9 is a diagram illustrating an example of the AI-driven fine-tuning and tokenization process within the AI security analysis engine framework 900, which enhances the system’s ability to conduct automated security assessments, penetration testing, and vulnerability detection. This figure outlines a structured workflow that leverages reinforcement learning, continuous adaptation, and intelligent tokenization techniques to optimize AI performance in cybersecurity applications.

In the illustrated embodiment, the process begins with input data sources, e.g., dataset 902, which may include security logs, exploit simulation reports, real-world attack data, and external threat intelligence feeds. These inputs may serve as the foundational knowledge base for the AI system, ensuring that it has access to the latest cybersecurity threats, vulnerabilities, and attack methodologies.

Once collected, the raw data may undergo a preprocessing and tokenization phase 904. Here, the system may employ advanced tokenization algorithms to segment and structure the data into meaningful representations. This step is crucial in transforming unstructured security logs and reports into a format that can be efficiently processed by machine learning models. The tokenized data preserves information about attack vectors, network vulnerabilities, and exploit patterns, ensuring that the AI can extract relevant insights for training and decision-making.

Following preprocessing and tokenization 904, the structured data may be provided to an AI security analysis engine 906 configured to perform model training, inference, and adaptive learning operations. The AI security analysis engine may apply various artificial intelligence or machine learning techniques to evaluate cybersecurity telemetry, identify vulnerabilities, predict potential attack paths, and assist in automated penetration testing operations. Example techniques may include supervised learning models, unsupervised clustering algorithms, reinforcement learning systems, neural network architectures, transformer-based models, graph-based learning models, probabilistic inference models, or other artificial intelligence techniques suitable for analyzing cybersecurity data. The AI engine may improve its predictive capabilities over time using feedback derived from prior penetration tests, vulnerability assessments, expert security analysis, and evolving threat intelligence.

In some embodiments, the AI security analysis engine may utilize multiple specialized models operating together, such as vulnerability classification models, exploit success probability models, attack path prediction models, and risk prioritization models. These models may be trained using historical penetration testing results, vulnerability databases, network configuration data, and external threat intelligence feeds.

Once fine-tuned, the AI model may be deployed for security assessment and penetration testing 908. During this stage, the AI model, e.g., AI security analysis engine in some example embodiments, may utilizes its enhanced models to perform real-time exploit simulations, vulnerability scanning, and attack surface analysis. The AI may assess network security postures, executes controlled penetration tests, and evaluates the effectiveness of various attack methodologies in a secure, sandboxed environment. The findings from these tests may be compiled into detailed security reports, providing organizations with actionable insights and mitigation strategies.

In some example embodiments, a feature of the AI security analysis engine framework may be its feedback loop and continuous learning mechanism. After conducting penetration tests, the AI system analyzes the outcomes, evaluates the effectiveness of its attack simulations, and integrates these results back into the fine-tuning process. This cyclical refinement ensures that the AI remains adaptive and responsive to new security challenges, constantly enhancing its risk assessment accuracy and exploit validation capabilities.

Ultimately, FIG. 9 encapsulates an example end-to-end lifecycle of AI-driven cybersecurity adaptation, demonstrating how tokenized data, reinforcement learning, and continuous AI model refinement work together to create a highly responsive, intelligent penetration testing system. By leveraging real-time security intelligence and automated exploit validation, AI security analysis engine delivers an evolving, self-improving security framework capable of defending against modern cyber threats.

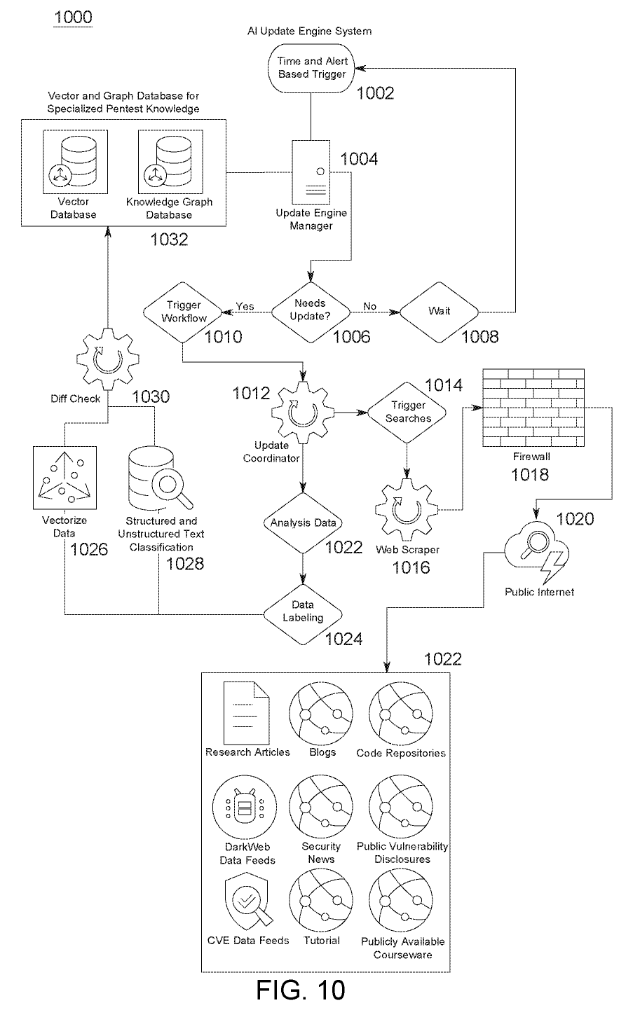

FIG. 10 illustrates an example AI update engine system 1000 configured to automatically gather cybersecurity intelligence, process the intelligence into structured knowledge representations, and update knowledge repositories used by an automated penetration testing platform. The system 1000 may operate continuously or periodically to ensure that the penetration testing platform remains aware of newly disclosed vulnerabilities, exploit techniques, and attack methodologies.

In some embodiments, the update process may be initiated by a time and alert based trigger 1002, which may generate update events based on scheduled intervals, detection of newly disclosed vulnerabilities, external alert feeds, or other monitoring signals. The trigger 1002 may activate an update engine manager 1004, which manages update workflows and determines whether new intelligence processing operations should be performed. For example, the update engine manager 1004 may evaluate a needs update decision stage 1006 to determine whether relevant updates are available. If no update is required, the system may enter a wait state 1008 until a subsequent trigger occurs. If an update is required, the update engine manager 1004 may initiate an automated trigger workflow 1010.

The trigger workflow 1010 may invoke an update coordinator 1012, which orchestrates multiple data collection and processing operations across the update engine system 1000. The update coordinator 1012 may initiate trigger searches 1014 to identify and retrieve cybersecurity intelligence from external information sources. In some embodiments, a web scraper 1016 or other automated retrieval component may be used to collect information from publicly accessible systems. Communications between the update engine and external data sources may pass through a firewall 1018 before accessing the public internet 1020 to obtain security intelligence.

External cybersecurity information may originate from a variety of sources collectively represented as data sources 1022. Such sources may include research articles, technical blogs, software code repositories, dark web intelligence feeds, security news services, public vulnerability disclosure platforms, CVE (Common Vulnerabilities and Exposures) data feeds, tutorials, publicly available training material, and other cybersecurity intelligence sources.

Retrieved information may then be processed through a data labeling stage 1024, in which collected information may be classified, normalized, and tagged with metadata identifying vulnerability types, attack techniques, affected software systems, exploit characteristics, and other contextual attributes. The system may perform vectorization operations 1026, which transform textual or structured information into vector embeddings suitable for machine learning and semantic search. In addition, structured and unstructured text classification operations 1028 may categorize incoming intelligence according to predefined or dynamically generated taxonomies.

In some embodiments, a difference detection process 1030 may compare newly retrieved information with existing knowledge records in order to identify newly disclosed vulnerabilities, exploit techniques, attack paths, or other cybersecurity intelligence updates. Detected updates may then be incorporated into a vector and graph database system 1032, which may include both a vector database and a knowledge graph database.

The vector database may store vector embeddings of cybersecurity knowledge to enable semantic search, similarity analysis, and retrieval-augmented generation (RAG) processes. The knowledge graph database may store relational cybersecurity data representing relationships among vulnerabilities, systems, software components, attack techniques, exploits, and defensive mitigations. Together, the vector database and knowledge graph database may form a continuously evolving repository of specialized penetration testing knowledge that is accessible to AI agents, automated testing modules, and security analysis components within the penetration testing platform.

By continuously ingesting cybersecurity intelligence and updating the vector and graph knowledge repositories, the AI update engine system 1000 may enable the platform to dynamically adapt to newly emerging threats and vulnerabilities without requiring manual rule updates or predefined exploit scripts.

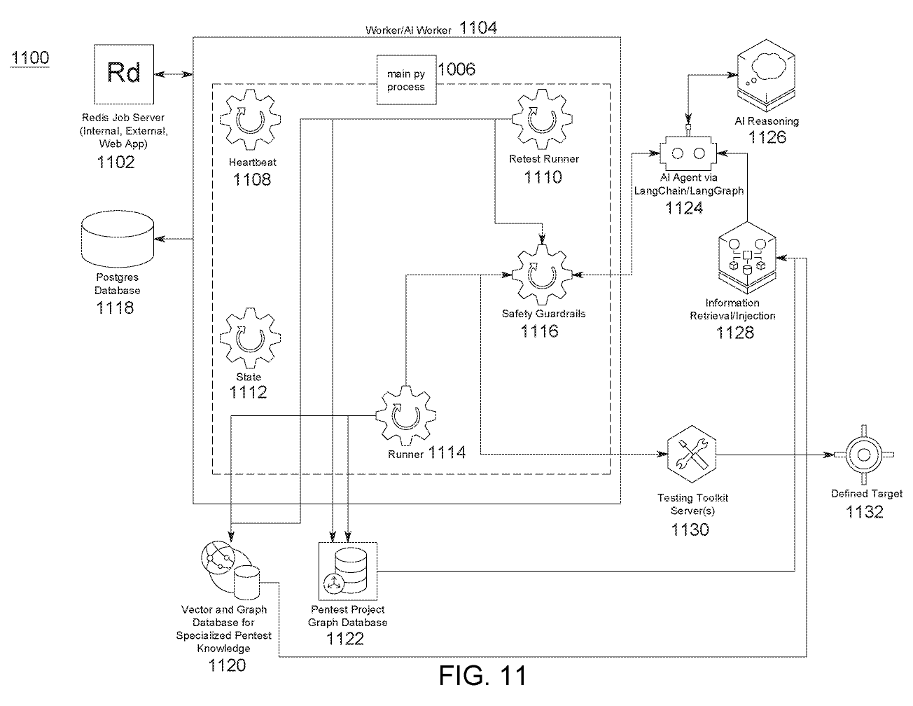

FIG. 11 illustrates an example distributed worker architecture 1100 for executing automated penetration testing operations using specialized artificial intelligence agents. In some embodiments, the architecture may include one or more worker systems 1104 configured to retrieve penetration testing tasks, coordinate AI reasoning processes, and execute testing operations against a defined target environment.

The worker system 1104 may retrieve tasks from a job server 1102, which may include a Redis or similar queue-based task management system configured to distribute testing jobs originating from internal systems, external scanning services, or web application testing modules. The job server 1102 may store project tasks and testing workflows that are assigned to available worker systems for execution. The worker systems may also interact with a project database 1118, such as a PostgreSQL database or other relational datastore, that maintains project state information, execution logs, and penetration testing metadata. In some embodiments, the project database may also store discovered vulnerabilities, security findings, affected assets, remediation recommendations, and associated severity scores generated during the penetration testing process. The stored information may be used to maintain a persistent record of testing activities and may support generation of reports, dashboards, and client-facing summaries. For example, a web portal or application interface may query the project database to display discovered vulnerabilities, testing progress, historical findings, and remediation status to authorized users associated with the penetration testing engagement.

Within the worker system 1104, a central main process 1106 may coordinate the execution of penetration testing tasks. The main process 1106 may manage several internal operational modules including a heartbeat module 1108, a retest runner 1110, a state management module 1112, a task runner 1114, and safety guardrails 1116. The heartbeat module 1108 may periodically communicate with the job server 1102 to confirm that the worker system remains active and capable of executing assigned tasks. The retest runner 1110 may initiate follow-up scans or verification tasks when vulnerabilities require confirmation or validation. The state management module 1112 may maintain task execution states, ensuring continuity of testing operations across multiple processing steps. The task runner 1114 may coordinate execution of penetration testing activities by invoking external tools and AI reasoning processes. The safety guardrails 1116 may enforce operational constraints designed to prevent unauthorized actions, limit testing scope to authorized targets, and ensure compliance with engagement rules of engagement (ROE).

In some embodiments, the worker system 1104 may utilize an AI agent 1124, which may be implemented using orchestration frameworks such as LangChain, LangGraph, or similar multi-agent execution environments. The AI agent 1124 may perform automated reasoning using an AI reasoning engine 1126, which may include one or more large language models (LLMs), fine-tuned machine learning models, or other artificial intelligence systems configured to analyze penetration testing results and determine appropriate next actions. The AI reasoning engine 1126 may interact with an information retrieval and injection system 1128, which retrieves relevant contextual knowledge from cybersecurity knowledge repositories.

The information retrieval and injection system 1128 may access a vector and graph database system 1120 containing specialized penetration testing knowledge. The vector database may store semantic embeddings of cybersecurity intelligence, while the graph database may represent relationships among vulnerabilities, assets, attack paths, and exploit techniques. The worker system may also access a penetration testing project graph database 1122, which stores project-specific information including discovered hosts, vulnerabilities, system relationships, and testing results.

Based on AI reasoning results and retrieved contextual knowledge, the worker system 1104 may invoke external testing tools through one or more testing toolkit servers 1130. These toolkit servers may host penetration testing utilities, vulnerability scanners, exploit frameworks, or other security testing tools capable of interacting with a defined target environment 1132. The defined target environment 1132 may represent a client network, web application infrastructure, internal systems, or other authorized testing targets.

Through this architecture, the distributed worker system 1104 may autonomously coordinate penetration testing activities by combining AI-driven reasoning, knowledge graph retrieval, and automated tool execution. The modular structure of the worker system allows multiple workers to operate concurrently, enabling scalable testing operations across multiple target environments while maintaining centralized coordination through the job server 1102 and project databases.

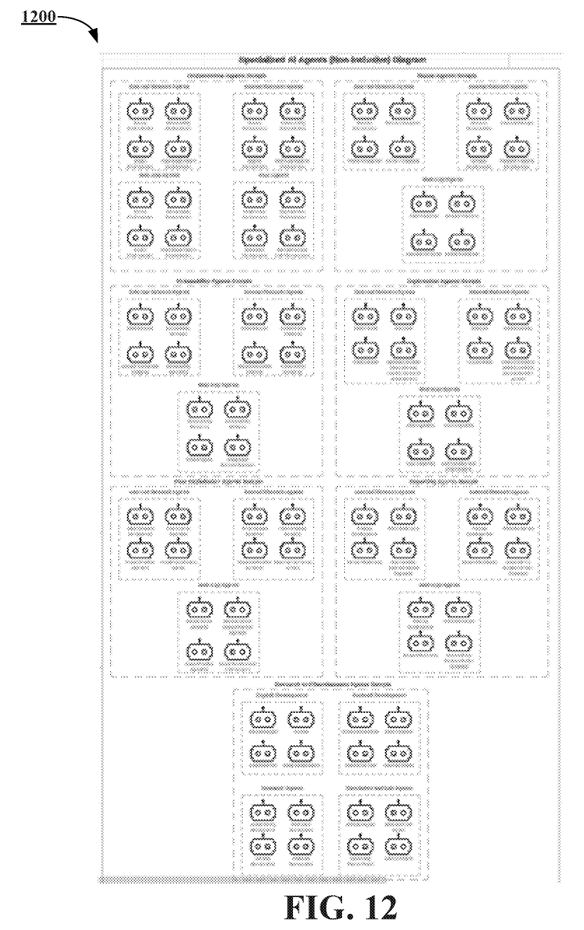

FIG. 12 illustrates an example specialized artificial intelligence (AI) agent architecture 1200 used within the automated penetration testing platform. In some embodiments, the architecture 1200 may include a plurality of specialized AI agents organized into functional groups that perform different stages of penetration testing operations. Rather than relying on a single generalized AI system, the platform may deploy multiple smaller AI agents that are specialized for particular testing domains, attack techniques, or security analysis tasks.

As shown in FIG. 12, the specialized AI agents may be grouped according to operational categories including external reconnaissance agents, web application testing agents, internal network testing agents, exploit development agents, and post-exploitation agents. Each group may include multiple cooperating AI agents configured to analyze information, generate testing strategies, and perform automated reasoning associated with specific attack surfaces or security domains.

For example, reconnaissance agents may analyze target environments to identify exposed systems, services, and potential entry points. External infrastructure agents may evaluate internet-facing assets such as public servers, network gateways, cloud services, and exposed administrative interfaces to identify vulnerabilities, misconfigurations, or exploitable services accessible from external networks. Web application agents may evaluate application endpoints for vulnerabilities such as cross-site scripting (XSS), injection attacks, authentication weaknesses, or configuration errors. Internal network agents may analyze internal infrastructure to identify lateral movement opportunities, privilege escalation paths, or misconfigured services. Exploit development agents may determine potential exploit chains based on discovered vulnerabilities, while post-exploitation agents may analyze persistence techniques, credential harvesting opportunities, and data exfiltration paths.

In some embodiments, the specialized AI agents may operate cooperatively as part of a multi-agent orchestration framework, allowing different agents to exchange information, share intermediate findings, and coordinate attack workflows. By dividing penetration testing tasks among specialized AI agents, the platform may improve analytical accuracy, reduce computational overhead, and prevent context loss that may occur when a single AI model attempts to process the entire testing workflow.

The specialized AI agent architecture 1200 therefore enables scalable, domain-focused security analysis in which individual agents act as subject-matter experts for particular attack techniques or security domains while still contributing to an overall coordinated penetration testing process.

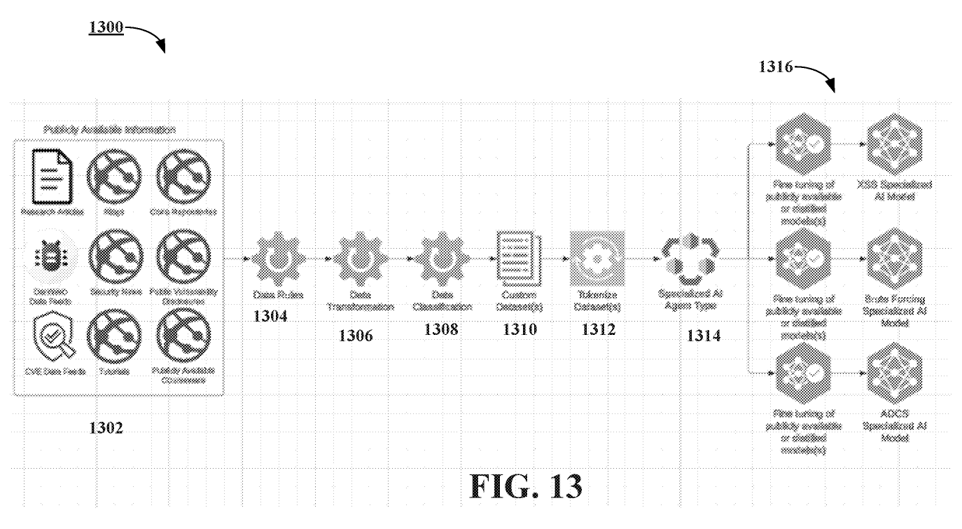

FIG. 13 illustrates an example pipeline 1300 for generating specialized artificial intelligence models used by the automated penetration testing platform. The pipeline 1300 may collect publicly available cybersecurity information, process the information into structured datasets, and generate specialized AI models configured to analyze specific types of vulnerabilities or attack techniques.

As shown in FIG. 13, the pipeline may begin with the collection of publicly available information sources 1302. These sources may include research articles, technical blogs, software code repositories, dark web data feeds, security news sources, public vulnerability disclosures, CVE data feeds, tutorials, and publicly available training materials. Information gathered from these sources may provide cybersecurity intelligence relating to vulnerabilities, exploits, attack techniques, and defensive mitigations.

The collected information may then be processed through a sequence of data preparation stages. In some embodiments, data rules 1304 may define filtering, validation, and normalization operations applied to incoming information. The filtered data may then undergo data transformation operations 1306, which may convert raw content into structured or machine-readable formats. The transformed data may then be categorized during a data classification stage 1308, where information may be organized according to vulnerability types, attack categories, affected systems, or exploit characteristics.

Following classification, the processed information may be assembled into custom datasets 1310, which may be curated collections of cybersecurity intelligence relevant to particular testing domains. The datasets may then be processed through tokenization operations 1312, which convert textual or structured data into tokenized representations suitable for machine learning model training.

Based on the tokenized datasets, the system may define one or more specialized AI agent types 1314 corresponding to different cybersecurity analysis functions. These specialized agent types may be used to generate or train domain-specific artificial intelligence models through model training and fine-tuning operations 1316. In some embodiments, the models may be derived from publicly available machine learning models, distilled models, or internally developed base models that are further fine-tuned using the curated datasets.

The resulting models may include specialized cybersecurity analysis models such as cross-site scripting (XSS) analysis models, brute-force attack detection models, Active Directory Certificate Services (ADCS) exploitation models, or other vulnerability-specific models configured to analyze particular attack vectors or system configurations.

By generating multiple specialized AI models trained on curated cybersecurity intelligence, the system may enable AI agents within the penetration testing platform to perform domain-specific reasoning and analysis during automated security assessments. This architecture allows the platform to maintain specialized expertise across different vulnerability classes while enabling coordinated multi-agent penetration testing workflows.

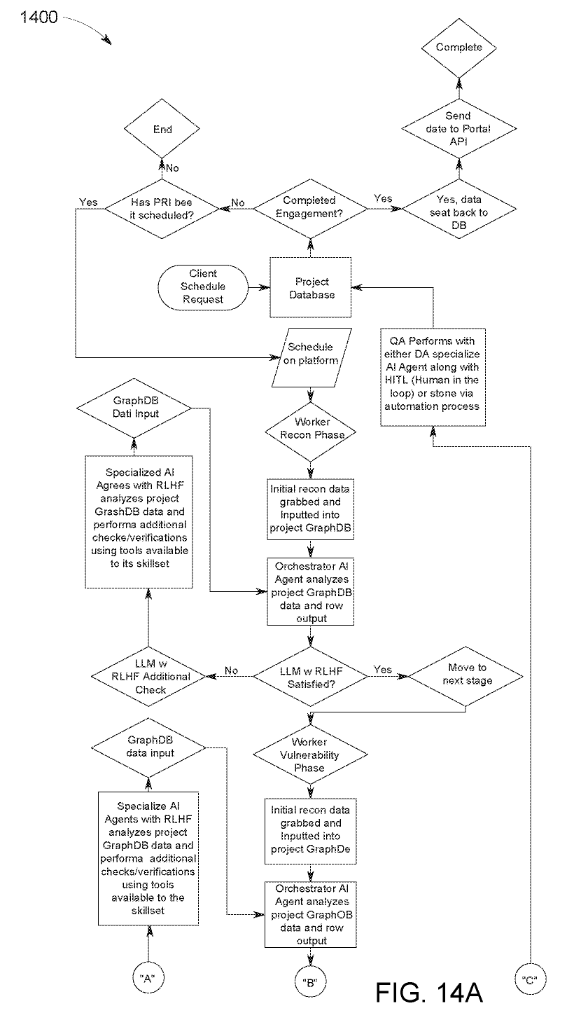

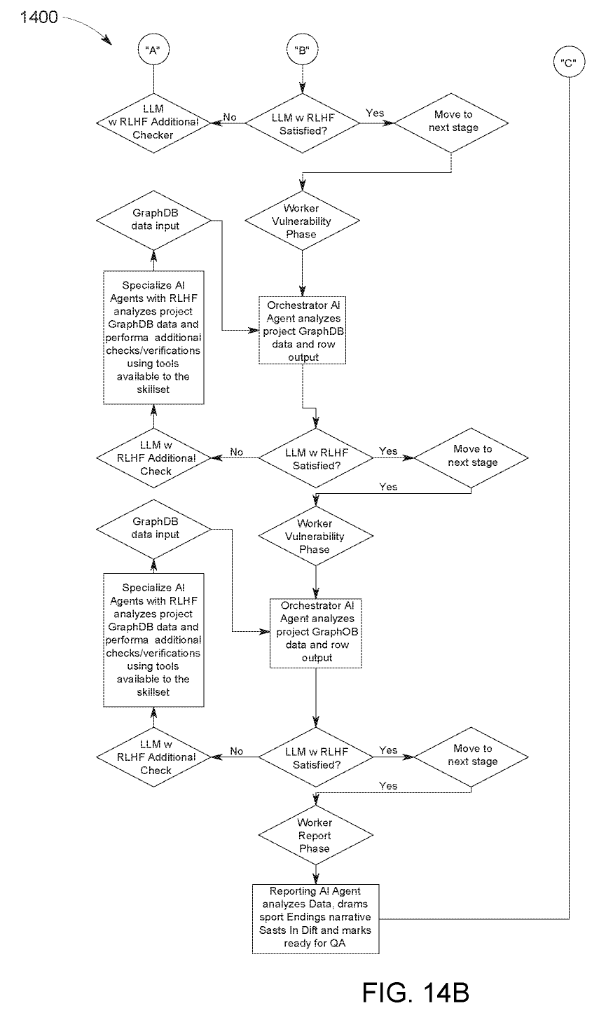

FIG. 14A illustrates an example automated penetration testing engagement workflow 1400, which may govern the scheduling, orchestration, execution, validation, and completion of penetration testing activities within the platform. In some embodiments, the workflow 1400 may coordinate interactions between client scheduling requests, project data storage, graph-based data ingestion, artificial intelligence analysis engines, specialized testing agents, and validation mechanisms to ensure that testing results are reliable before being delivered to a client portal.

In some embodiments, the workflow may begin with an end-state or loop control node, which determines whether the current engagement cycle has completed. If the workflow determines that the engagement cycle has not completed, the process may transition to a schedule verification stage in which the system determines whether a penetration testing engagement has been scheduled.

The scheduling determination may occur through a schedule-check decision node that evaluates whether a penetration testing request has been received through the system scheduler. If no request has been received, the workflow may remain in a waiting state until a scheduling request becomes available. If a request has been received, the workflow may transition into an engagement initialization stage.

In some embodiments, a penetration testing engagement may begin with a client schedule request, which may be generated through a client-facing interface, automated subscription scheduling mechanism, compliance monitoring trigger, or other client interaction. The client schedule request may include engagement parameters such as target domains, IP ranges, application endpoints, testing scope definitions, permitted testing windows, authentication credentials, or other engagement constraints.

Upon receiving the client schedule request, the workflow may insert the request into a project database, which may function as a persistent storage system for engagement metadata. The project database may store project identifiers, scope definitions, scheduling parameters, testing configuration information, and intermediate results generated during the engagement lifecycle.

After storing the scheduling request within the project database, the workflow may transition into a schedule activation stage. In this stage, the system may register the engagement within the platform scheduler and prepare the environment necessary to begin testing activities. The scheduler may coordinate execution timing, allocate computing resources, assign agent workers, and ensure that testing occurs within the permitted time window defined by the client request.

Once the engagement has been activated within the platform scheduler, the workflow may transition into a worker reconnaissance phase, which represents the beginning of active data collection and analysis activities.

In some embodiments, the worker reconnaissance phase may begin with the initial ingestion of reconnaissance data into a project graph database. The project graph database may store graph-structured representations of discovered assets, network infrastructure components, application elements, vulnerabilities, authentication mechanisms, and other security-relevant entities.

The ingestion process may insert initial reconnaissance data such as discovered domains, subdomains, network hosts, IP addresses, open ports, service banners, application endpoints, and related metadata into the graph database. This data may serve as the initial dataset from which subsequent AI agents perform analysis.

After the initial data ingestion stage, the workflow may invoke an orchestrator artificial intelligence agent responsible for coordinating specialized testing agents. The orchestrator AI agent may analyze the contents of the project graph database and determine which specialized testing agents should be invoked to further analyze the discovered infrastructure.

The orchestrator AI agent may perform reasoning operations that evaluate graph relationships, vulnerability likelihood scores, reconnaissance indicators, or contextual security intelligence. Based on this analysis, the orchestrator may select appropriate specialized agents to perform additional reconnaissance tasks, vulnerability assessments, or exploitation simulations.

In some embodiments, the orchestrator artificial intelligence agent may function as a phase-specific orchestration component responsible for coordinating specialized testing agents associated with a particular stage of the penetration testing workflow. For example, separate orchestrator agents may manage reconnaissance analysis activities, vulnerability assessment operations, exploitation simulations, post-exploitation evaluation, or reporting tasks. Each orchestrator agent may act as a phase manager that determines which specialized AI agents or analysis models should be invoked within that phase. For instance, during a vulnerability assessment phase the orchestrator agent may selectively invoke agents configured to evaluate web application vulnerabilities such as cross-site scripting (XSS), injection conditions, authentication weaknesses, or other vulnerability classes. The orchestrator agent may therefore coordinate the operation of multiple specialized AI agents while maintaining overall workflow control within the phase.

In some embodiments, the workflow may include a graph data input stage, which represents the entry of additional reconnaissance or contextual information into the graph database. This stage may occur repeatedly as new data is discovered during testing operations.

After data is inserted into the graph database, the workflow may invoke specialized artificial intelligence agents configured to perform advanced analysis of the collected information. These agents may operate using reinforcement learning techniques or other adaptive learning mechanisms models or other machine learning architectures that analyze graph relationships and contextual security intelligence.

The specialized agents may evaluate the graph database to identify possible vulnerabilities, misconfigurations, weak authentication mechanisms, exposed services, or exploitable software components. In some embodiments, the specialized agents may also perform validation checks to ensure that potential findings are accurate and not false positives.

Following the specialized agent analysis stage, the workflow may transition to a validation decision stage that determines whether additional verification is required. In some embodiments, the workflow may perform a large language model (LLM) validation with RLHF, which may analyze the findings generated by the specialized agents.

The LLM validation stage may evaluate whether the identified vulnerabilities or attack paths are consistent with known exploit conditions, vulnerability intelligence, or previously observed attack patterns. If the LLM validation determines that additional verification is required, the workflow may return to earlier stages to perform further graph analysis or data collection.

If the validation stage determines that the findings are sufficiently verified, the workflow may proceed to a worker vulnerability phase, which represents the stage at which confirmed vulnerability data is processed and prepared for reporting.

During the worker vulnerability phase, initial vulnerability data may be inserted into the project graph database. This data may include vulnerability identifiers, affected assets, severity scores, exploitation conditions, and associated evidence collected during testing.

After vulnerability data has been inserted into the graph database, the workflow may once again invoke the orchestrator AI agent, which may analyze the vulnerability data stored in the graph. The orchestrator may determine whether additional testing agents should be invoked to further analyze the vulnerabilities or whether the vulnerabilities have been sufficiently validated.

In some embodiments, the orchestrator may instruct additional specialized agents to perform further verification or enrichment of vulnerability findings. These agents may perform activities such as vulnerability classification, exploit simulation, evidence verification, or contextual enrichment using threat intelligence sources.

The workflow may include additional validation decision nodes to determine whether further analysis or verification is necessary. If additional analysis is required, the workflow may return to the graph data input stage or the specialized agent analysis stage.

If the orchestrator determines that the vulnerability data has been sufficiently verified, the workflow may proceed to a quality assurance stage. In this stage, the system may perform QA validation of the vulnerability findings.

The QA validation stage may involve evaluating whether the vulnerability corresponds to known vulnerability categories such as Common Vulnerabilities and Exposures (CVE) entries, Hypertext Transfer Protocol (HTTP) vulnerabilities, server misconfigurations, or other vulnerability classes. The QA validation stage may also confirm that sufficient evidence exists to support each vulnerability finding.

After QA validation is completed, the workflow may transition to a completion determination stage, which evaluates whether the engagement has completed. If additional testing tasks remain, the workflow may return to earlier stages of the process to continue testing operations.

If the engagement is determined to be complete, the workflow may proceed to a completion node, which triggers a data transmission stage responsible for sending results to a client portal application programming interface (API).

The portal API may serve as an interface between the penetration testing platform and a client-facing portal through which clients may view testing results. The API may transmit validated vulnerability findings, testing summaries, and supporting evidence to the portal environment.

In some embodiments, the portal API may format the results for presentation within dashboards, reports, or alert notifications. Clients may access the portal to review identified vulnerabilities, analyze security posture metrics, and obtain remediation recommendations.

Following transmission of the results through the portal API, the workflow may update the project database to reflect that the engagement has completed. The workflow may then return to the end-state loop control node, where the system may wait for additional scheduled engagements.

In some embodiments, the workflow illustrated in FIG. 14A may operate continuously across multiple projects and clients. The platform scheduler may manage multiple simultaneous engagement workflows, each operating independently but following the general orchestration pattern illustrated in the figure.

Accordingly, the workflow shown in FIG. 14A may represent a comprehensive orchestration pipeline in which client scheduling requests initiate testing engagements, reconnaissance data is ingested into a graph-based data model, artificial intelligence agents analyze the graph to identify vulnerabilities, validation mechanisms confirm the findings, and verified results are delivered to clients through a portal interface.

FIG. 14B illustrates a continuation of the automated penetration testing workflow 1400, particularly stages associated with post-exploitation analysis, verification of testing results, and automated report preparation. The workflow shown in FIG. 14B may represent the downstream processing stages that occur after reconnaissance and vulnerability identification operations have been performed within the system.

In some embodiments, the workflow of FIG. 14B may begin at a first transition point labeled “A.” The transition point may represent the output of earlier workflow stages in which reconnaissance data and vulnerability data have been collected and processed. At this point in the workflow, the system may determine whether additional validation steps should be performed on previously generated analysis results.

Following transition point “A,” the workflow may enter an additional verification stage, which may include a decision node representing whether additional large language model (LLM) verification combined with reinforcement learning from human feedback (RLHF) should be performed. In some embodiments, the LLM with RLHF may be used to perform contextual validation of previously generated findings, to determine whether additional analysis is necessary, and to detect potential false positives or incomplete data relationships.

If the LLM validation determines that further verification is required, the workflow may route the data to a specialized artificial intelligence agent analysis stage. In this stage, specialized AI agents configured with reinforcement learning from human feedback models may analyze graph-based project data stored within the platform. These specialized agents may perform deeper analysis of relationships within the project graph database, evaluate raw testing output generated by worker agents, and perform additional verification procedures using automated tools available within the platform environment.

For example, specialized AI agents may perform activities such as confirming vulnerability exploitation conditions, validating service configurations, rechecking endpoint responses, verifying credential exposures, analyzing authentication behavior, or confirming the presence of software vulnerabilities through secondary verification mechanisms. These agents may also invoke auxiliary tools to validate network responses, confirm system states, or reproduce exploitation conditions.

During this stage, the workflow may incorporate graph database data input, which may represent the ingestion of updated information into the project graph database. This data may include additional reconnaissance information, new vulnerability evidence, or supplementary metadata collected during verification activities. The graph database may maintain relationships between discovered infrastructure components, vulnerabilities, authentication mechanisms, and testing artifacts.

After additional verification by the specialized AI agents has been completed, the workflow may return to a secondary LLM validation stage. In this stage, the system may again invoke an LLM model trained using RLHF techniques to determine whether the verification results are satisfactory. The LLM may evaluate the combined data produced by the specialized agents and determine whether the findings are sufficiently validated.

If the LLM determines that further analysis is still required, the workflow may again loop through the specialized agent verification stage to perform additional testing and validation operations. This iterative process may continue until the system determines that the verification results are sufficiently reliable.

Once the LLM validation stage determines that the results are satisfactory, the workflow may proceed to a second transition point labeled “B.” The transition point “B” may represent a point in the workflow at which verified vulnerability findings are ready to proceed into the post-exploitation processing stage.

From transition point “B,” the workflow may proceed to a worker post-exploitation phase. In this phase, worker agents responsible for post-exploitation activities may analyze previously identified vulnerabilities and exploitation opportunities to determine whether additional post-exploitation operations should be simulated or evaluated.

The post-exploitation phase may include tasks such as analyzing potential privilege escalation opportunities, identifying lateral movement possibilities within a target environment, evaluating persistence mechanisms, or determining whether sensitive data may be accessible following successful exploitation. Worker agents operating in the post-exploitation phase may generate additional output data representing possible attack paths, system states, or exploitation outcomes.

Following the post-exploitation phase, the workflow may invoke an orchestrator artificial intelligence agent responsible for coordinating additional analysis operations. The orchestrator AI agent may evaluate the contents of the project graph database as well as raw output generated by worker agents during post-exploitation analysis.

The orchestrator AI agent may perform reasoning operations to determine whether the collected data is sufficient to produce meaningful vulnerability findings or whether additional analysis should be performed. For example, the orchestrator may examine graph relationships between vulnerabilities, affected systems, credentials, and exploitation outcomes to identify potential attack chains or escalation pathways.

After the orchestrator AI agent completes its analysis, the workflow may again invoke an LLM validation stage to determine whether the data produced by the post-exploitation analysis and orchestration steps meets quality requirements. This stage may again use reinforcement learning from human feedback techniques to assess the validity and completeness of the generated results.

If the validation stage determines that additional verification is required, the workflow may return to the earlier specialized AI agent analysis stage to perform further validation checks. These additional checks may include reanalyzing graph relationships, executing verification tools, or collecting additional evidence from the target environment.

If the validation stage determines that the results are satisfactory, the workflow may proceed to a transition stage labeled “C.” This stage may represent the point at which validated post-exploitation results are ready to move to the next stage of the platform pipeline.

The next stage of the workflow may involve a worker reporting phase. In this phase, worker agents may transform the validated technical findings into structured report data suitable for presentation to a client.

During the reporting phase, the workflow may invoke a reporting artificial intelligence agent. The reporting AI agent may analyze collected vulnerability data, post-exploitation results, evidence gathered during testing, and contextual information stored within the project graph database.

The reporting AI agent may generate structured vulnerability findings and may draft descriptive narrative content explaining the discovered vulnerabilities, attack paths, and potential impacts. The narrative content may include explanations of vulnerability conditions, descriptions of affected assets, severity assessments, and suggested remediation guidance.

In some embodiments, the reporting AI agent may format the generated findings into report structures compatible with downstream reporting systems. The agent may prepare vulnerability summaries, technical evidence sections, risk descriptions, and remediation recommendations.

After the report content has been generated, the workflow may send the prepared report data to a database system where the report artifacts may be stored. The stored data may include both structured vulnerability data and narrative report text generated by the reporting AI agent.

The reporting workflow may also mark the generated report as ready for quality assurance review. In some embodiments, a subsequent quality assurance stage may be performed by either automated validation agents or human reviewers to ensure that the generated report content meets platform standards.

Following completion of the reporting phase, the workflow may return to earlier stages of the engagement lifecycle or may proceed to client-facing reporting systems where the validated results may be delivered through a client portal interface.

Accordingly, the workflow illustrated in FIG. 14B may represent a post-exploitation and reporting pipeline in which validated vulnerability findings are further analyzed, orchestrated through graph-based reasoning, processed through iterative validation stages, and ultimately converted into structured security reports that can be delivered to clients through automated reporting systems.

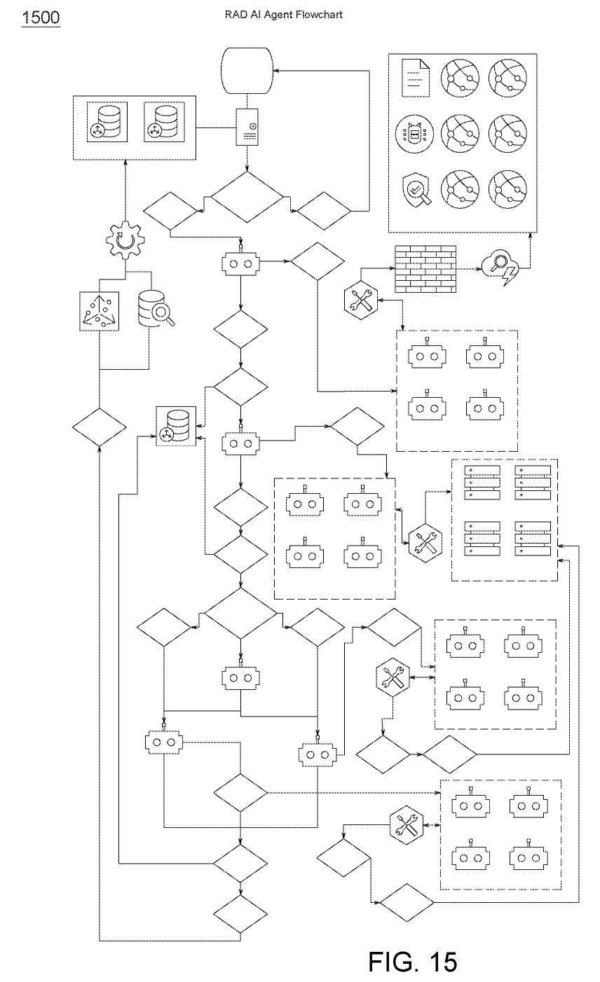

FIG. 15 illustrates an example research and development artificial intelligence agent workflow 1500 for generating, validating, and incorporating cybersecurity intelligence, exploit techniques, payloads, and laboratory-tested penetration testing knowledge into the platform. In some embodiments, the workflow 1500 may be used by a research and development environment that continuously updates the penetration testing platform with newly discovered attack techniques, exploit methodologies, detection logic, payload behavior, and related cybersecurity intelligence.

In some embodiments, the workflow 1500 may begin with a manual or automated research target acquisition trigger, which may initiate research activity based on time-driven schedules, event-driven conditions, security alerts, newly disclosed vulnerabilities, internal research priorities, exploit development requests, or observed gaps in testing coverage. The trigger may initiate a workflow that determines whether a selected research topic, target vulnerability, attack technique, or exploit chain has already been researched or updated. If the topic has already been sufficiently researched, the workflow may enter a wait or idle state until a subsequent trigger occurs. If the topic has not yet been researched, or if updated analysis is required, the workflow may proceed to active research operations.

The workflow 1500 may interact with a vector and graph database for specialized penetration testing knowledge. In some embodiments, this knowledge repository may include a vector database storing semantic embeddings of cybersecurity information and a knowledge graph database storing relational data representing vulnerabilities, systems, attack techniques, exploit chains, and defensive mechanisms. The workflow may also interact with a difference detection stage, which may compare newly collected research information with existing platform knowledge to determine whether the information is novel, updated, or duplicative. Newly identified knowledge may be passed through stages such as vectorization, structured and unstructured text classification, and data labeling, thereby transforming raw research material into machine-consumable knowledge suitable for downstream AI reasoning, training, and workflow execution.

In some embodiments, the workflow may include a research orchestration layer that routes research tasks to appropriate agent systems. For example, when a target topic is selected, the workflow may determine whether the topic should be directed to a research graph, a vulnerability analysis path, a simulation path, a payload development path, or an exploit development path. A research graph database may be used to store intermediate research findings, source attribution, observed exploit conditions, proof-of-concept relationships, and graph-linked contextual knowledge associated with a particular research target or vulnerability class.

The workflow may further include one or more specialized research agents, which may be grouped into a research agent system. In some embodiments, these agents may include a vulnerability researcher agent, a firmware researcher agent, a service researcher agent, and a software researcher agent. These agents may be selected based on the nature of the target under investigation. For example, the vulnerability researcher agent may analyze newly disclosed CVEs, weakness patterns, exploit preconditions, and mitigation bypass opportunities. The firmware researcher agent may evaluate embedded device firmware, appliance software, binary update packages, or hardware-facing management interfaces. The service researcher agent may analyze network protocols, service banners, exposed daemon behavior, or misconfiguration states. The software researcher agent may evaluate software packages, applications, libraries, dependencies, and version-specific exploit conditions. In some embodiments, one or more of these agents may operate concurrently on the same topic and may exchange findings through the research graph database or orchestration layer.

The workflow 1500 may obtain research input from multiple external information sources through a public internet connection passing through one or more firewalls. These sources may include research articles, blogs, code repositories, dark web data feeds, security news, public vulnerability disclosures, CVE data feeds, and publicly available courseware or tutorials. The research workflow may use automated retrieval tools, manual research operations, or combinations thereof to gather relevant material from these sources. Retrieved data may be analyzed, classified, and stored for later use in agent reasoning, lab simulation, exploit development, or payload generation.

In some embodiments, the workflow may include a research testing toolkit server that provides automated research tooling capable of collecting, validating, or enriching target intelligence. The toolkit server may host utilities for reconnaissance, code analysis, protocol interaction, service validation, binary analysis, exploit checking, or laboratory automation. The workflow may route research tasks to the toolkit server when agent-based reasoning determines that tool-assisted validation is appropriate.

The workflow 1500 may additionally include a simulation and lab orchestration path that determines whether a simulation and lab agent system should be invoked. When appropriate, a lab orchestration stage may queue one or more specialized lab agents. In some embodiments, these lab agents may include an Active Directory (AD) lab agent, a software lab agent, a lab firing range agent, and a lab command-and-control (C2) agent. The AD lab agent may recreate or analyze directory services, user/group relationships, delegation settings, trust relationships, or authentication abuse scenarios. The software lab agent may reproduce software deployment states, services, or application conditions associated with a target exploit or misconfiguration. The lab firing range agent may provide a contained environment for simulating attacks, defenses, detections, or exploit execution sequences. The lab C2 agent may simulate or coordinate command-and-control behavior, task routing, persistence actions, or exploit delivery logic within an isolated environment. In some embodiments, the workflow may create a lab environment based on topic or vulnerability, allowing agents to evaluate exploit behavior under controlled conditions.

The workflow may determine whether the research topic calls for exploit development, payload development, or both. If exploit development is appropriate, the workflow may route the topic to an exploit development orchestration path. In some embodiments, an exploit development orchestrator may queue one or more exploit development agents. These agents may include an Integrated Development Environment (IDE) debugger agent, a fuzzer agent, a code review agent, and a heap exploitation agent. The IDE debugger agent may analyze crash conditions, runtime behavior, exception states, or execution traces. The fuzzer agent may generate or mutate inputs to identify instability, unintended program states, or memory safety weaknesses. The code review agent may inspect source code, pseudocode, decompiled output, or intermediate representations to identify vulnerable logic or exploit preconditions. The heap exploitation agent may analyze memory allocation behavior, corruption primitives, use-after-free conditions, heap grooming strategies, or allocator-specific exploitation opportunities. One or more of these exploit development agents may interact with a research testing toolkit server and may store results in the research graph database.

If payload development is appropriate, the workflow may route the topic to a payload development orchestration path. In some embodiments, a payload development orchestrator may queue one or more payload development agents. These may include a code obfuscation agent, an AMSI bypass agent, a beacon builder agent, and a reverse shell agent. The code obfuscation agent may transform payload logic to reduce static detection, signature matching, or superficial inspection. The AMSI bypass agent may generate or test mechanisms for avoiding inspection by anti-malware scanning interfaces or analogous inspection mechanisms. The beacon builder agent may generate callback-capable payload components, communication stagers, or persistence-enabled agents. The reverse shell agent may construct or test payloads that establish remote interactive access channels. These payload development agents may also interact with a research testing toolkit server and may store resulting data, code fragments, metadata, or behavior profiles in the research graph database or associated repositories.

In some embodiments, the workflow may include explicit decision stages governing whether ability to access lab environments is required before proceeding with exploit or payload development. If such access is available, the relevant agents may execute in or against the designated lab environments. If not, the workflow may route the operation through alternative analysis or wait states until the necessary environments are available. Similar decision stages may govern whether research should continue, whether results are novel, whether enough data has been gathered, whether one branch should feed another branch, or whether developed artifacts should be forwarded for later use.

The workflow may further include stages labeled conceptually as exploit, payload, or exploit or payload development, which may represent the transition from research and simulation into generation of executable or semi-executable offensive artifacts. In some embodiments, exploit-oriented branches and payload-oriented branches may converge or diverge depending on the nature of the vulnerability or attack pattern. For example, a branch may begin with vulnerability research, proceed through simulation in a lab environment, then continue into exploit development, followed by payload development to support practical delivery, staging, persistence, or post-exploitation objectives. In other embodiments, payload development may occur independently of exploit development, for example where a payload is intended for social engineering, lateral movement, persistence testing, or defensive validation rather than direct vulnerability exploitation.

The workflow may also include one or more result evaluation stages, such as stages that determine whether a finding should be sent to a data repository, whether data results should be saved, whether a workflow branch has completed, or whether additional data is needed. In some embodiments, research results, exploit code, payload artifacts, and metadata may be uploaded to a code repository or another version-controlled storage system. This repository may store source code, proof-of-concept material, payload templates, exploit scripts, build configurations, or validation output generated during research operations.

The workflow 1500 may include repeated data labeling, data results, and data flow finalization stages that integrate validated research outputs back into platform knowledge systems. For example, if a newly developed exploit, payload, or attack chain is validated, the resulting data may be transformed into structured intelligence and inserted into the vector database, knowledge graph database, or research graph database. In some embodiments, the workflow may mark a research topic as finalized once exploit behavior, payload behavior, vulnerability conditions, and contextual metadata have been adequately captured. The finalized data may then become available to production AI agents, specialized models, worker systems, and automated penetration testing orchestration modules.

In some embodiments, the research and development workflow 1400 may therefore function as a closed-loop intelligence generation and validation system. The workflow may begin with external or internal triggers, proceed through topic-specific research and source collection, branch into simulation, exploit development, or payload development as needed, validate outputs through lab environments and toolkit servers, and then incorporate the resulting intelligence into the platform’s knowledge stores. This architecture may allow the penetration testing platform to continuously evolve its exploit knowledge, testing logic, and attack path understanding based on newly generated research rather than relying solely on static scripts or manually curated rules.

The workflow may also support human participation where appropriate. For example, a manual researcher may initiate a topic, review an intermediate result, select a branch for further development, or approve final data for ingestion into platform knowledge stores. In other embodiments, the workflow may proceed autonomously using orchestration logic and specialized AI agents without manual intervention, except for optional oversight, validation, or policy control.

Accordingly, FIG. 15 may represent an example end-to-end research and development pipeline in which specialized research agents, lab agents, exploit development agents, and payload development agents cooperate through orchestration logic, knowledge databases, toolkit servers, and controlled lab environments to produce validated cybersecurity knowledge for use by the automated penetration testing platform.

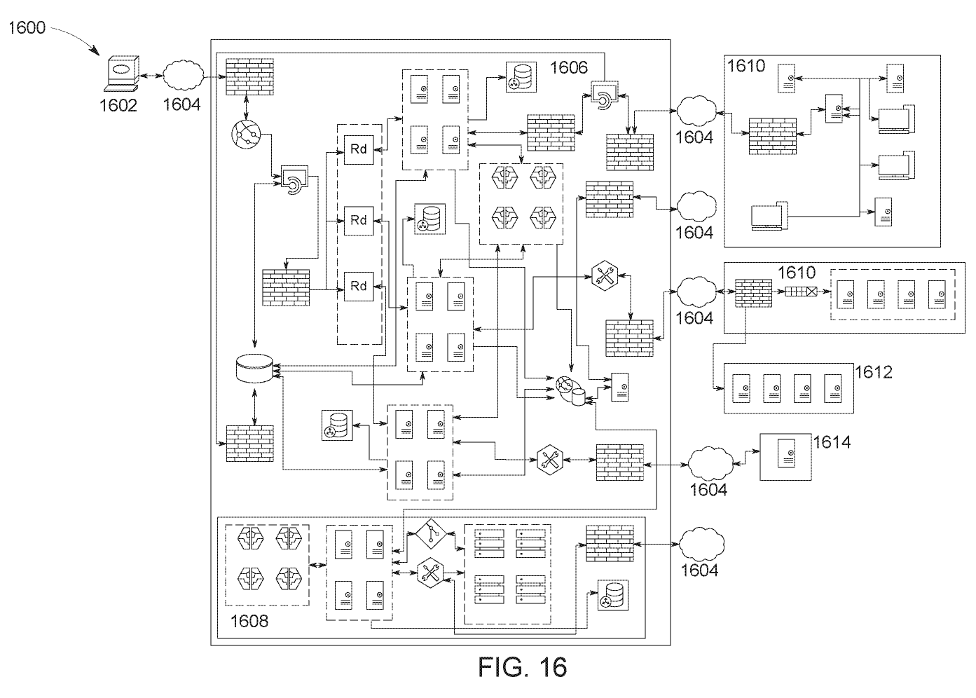

FIG. 16 illustrates an example automated penetration testing and attack surface management system architecture 1600. The architecture 1600 may represent an integrated platform that combines automated penetration testing infrastructure, artificial intelligence reasoning components, distributed worker systems, and external client environments.

In some embodiments, the system may be accessed through a user device 1602, which may represent a client workstation, administrator console, or other computing device used to interact with the penetration testing platform. The user device 1602 may communicate with the platform through the public internet 1604, which may connect to platform application interfaces and network security components.

Within the platform environment, the system may include a platform infrastructure environment 1606, which may represent the central operational environment of the penetration testing platform. The infrastructure environment 1606 may include multiple computing components such as application servers, vulnerability analysis servers, orchestration services, and worker systems used to coordinate automated testing operations.

For example, the infrastructure environment 1606 may include multiple worker nodes configured to execute automated testing tasks. These worker nodes may perform activities such as reconnaissance, vulnerability discovery, exploitation testing, and post-exploitation analysis. In some embodiments, the worker nodes may interact with a penetration testing project database that stores project configuration information, discovered assets, testing results, and vulnerability findings.

The infrastructure environment 1606 may further include one or more API gateway components, which may provide communication interfaces between the platform and external systems. The API gateway may allow platform services, client applications, or deployed testing appliances to transmit data, retrieve testing results, and coordinate testing workflows.

In some embodiments, the infrastructure environment 1606 may include artificial intelligence processing components. These components may include specialized AI agent systems configured to perform reasoning tasks related to penetration testing operations. The AI systems may analyze collected reconnaissance data, determine potential attack paths, generate testing strategies, and coordinate automated penetration testing activities. The AI components may operate in conjunction with knowledge repositories such as vector databases and penetration testing knowledge graphs, which store cybersecurity intelligence used to guide automated testing decisions.

The platform environment may also include external testing toolkit servers, which may host penetration testing utilities, vulnerability scanners, exploit frameworks, and other security testing tools. These toolkit servers may be invoked by worker nodes to perform testing operations against authorized target environments.

The infrastructure environment 1606 may further include network security components, such as firewalls and network segmentation controls, which regulate communications between platform components and external systems. These network controls may ensure that testing operations are conducted within authorized boundaries and that communication with client environments is performed through controlled interfaces.

In some embodiments, the architecture 1600 may also include a research and development environment 1608 that supports development and testing of new penetration testing capabilities. The research and development environment may include specialized AI training systems, development worker nodes, exploit research infrastructure, and testing laboratories used to develop new vulnerability detection techniques or attack simulation capabilities. The research environment may operate independently from production testing infrastructure but may periodically provide updated models, datasets, or testing methodologies to the platform environment.

The system may also communicate with client environments, which may represent the systems being tested during a penetration testing engagement. For example, the architecture may include an example client internal network 1610, which may represent an internal enterprise network environment including domain controllers, file servers, user workstations, and security appliances. The client internal network may include internal security devices, deployed penetration testing virtual machines, and internal services that may be evaluated during internal network testing.

The architecture may also include an example client external network 1610, which may represent externally accessible infrastructure such as internet-facing servers, network devices, and public services. These systems may be evaluated during external attack surface monitoring or external penetration testing operations.

In some embodiments, the system may also evaluate public-facing server environments 1612, which may represent externally accessible infrastructure such as web servers, application servers, or cloud-hosted services that are reachable from the public internet.

Additionally, the system may evaluate web application environments 1614, which may represent web-based services, APIs, or client web applications associated with the target organization. These applications may be analyzed for vulnerabilities such as injection flaws, authentication weaknesses, configuration errors, or other application-level security issues.

During operation, the platform infrastructure environment 1606 may coordinate automated testing operations across these client environments. Worker nodes and AI agents may collect reconnaissance data, identify potential vulnerabilities, invoke testing tools, and analyze results. The results of these operations may be stored within platform databases and knowledge repositories for further analysis and reporting.

Through this architecture, the platform may provide a distributed, AI-assisted penetration testing system capable of coordinating automated testing operations across multiple environments while maintaining centralized orchestration and security controls.

In some embodiments, the platform infrastructure environment 1606 may include multiple internal subsystems that cooperate to perform automated penetration testing operations. As illustrated in FIG. 16, the platform environment may include vulnerability worker nodes, web application worker nodes, and specialized artificial intelligence agent systems. The worker nodes may execute penetration testing tasks including reconnaissance, enumeration, vulnerability analysis, exploitation attempts, and post-exploitation analysis.

The platform infrastructure environment may further include a penetration testing project database, which may store project configuration information, target definitions, scan schedules, discovered vulnerabilities, and testing artifacts generated during automated penetration testing operations. The database may also store information used by AI agents to track testing coverage and coordinate testing workflows.

In some embodiments, the platform environment may also include API gateway services configured to provide communication interfaces between the penetration testing platform and external systems. The API gateway services may allow client applications, deployed testing appliances, or other platform components to submit requests, retrieve testing results, and exchange testing data with the platform infrastructure.

The platform environment may also include vector and graph knowledge databases, which may store cybersecurity intelligence and relationships among discovered assets, vulnerabilities, credentials, and attack paths. These knowledge repositories may be used by AI agents to retrieve contextual information during automated penetration testing operations.

The platform infrastructure may further include external testing toolkit servers, which may host penetration testing utilities, vulnerability scanners, exploit frameworks, and other security testing tools. These toolkit servers may be invoked by worker nodes or AI agents when executing testing operations against defined targets.

Additionally, the platform infrastructure may include network security components, including firewalls and network segmentation devices, which regulate communications between internal platform services and external networks. These security components may enforce access controls and ensure that testing operations remain restricted to authorized targets.The research and development environment 1608 may include additional internal components used for developing and testing new penetration testing techniques. As shown in FIG. 16, the research environment may include specialized AI agent systems, worker nodes, research databases, research testing toolkit servers, and development infrastructure used for vulnerability research and exploit simulation. The research environment may allow developers and researchers to test new detection methods, develop attack simulations, and train artificial intelligence models before deploying those capabilities to the production platform environment.

In some embodiments, the research environment may also include AI training infrastructure, which may be used to train or fine-tune machine learning models used by the automated penetration testing platform. The trained models may then be deployed to the platform infrastructure environment 1606 where they may be used by AI agents to assist with vulnerability analysis, attack path discovery, and automated testing decisions.

### Graph Database Representation of Penetration Testing Knowledge

In some embodiments, the penetration testing platform may store discovered security intelligence, testing artifacts, and attack path information within a graph-based database architecture. The graph database may represent cybersecurity entities as nodes and relationships between those entities as edges, enabling efficient representation of complex relationships among network assets, vulnerabilities, credentials, services, and exploit paths.

The graph database may be implemented using a graph database system such as FalkorDB, Neo4j, or another graph-oriented data store capable of representing interconnected cybersecurity data structures. In some embodiments, the graph database may operate alongside a vector database that stores semantic embeddings used for similarity search and retrieval operations. The graph database may therefore serve as a relational cybersecurity knowledge model that captures discovered infrastructure components and their security relationships during automated penetration testing operations.

### Project Isolation and Multi-Tenant Graph Architecture

In some embodiments, the platform may create a dedicated graph instance for each penetration testing engagement or project. This architecture may provide tenant isolation between different clients or testing environments. For example, separate graph instances may be created for different testing domains such as:
web application security testing engagements
external attack surface monitoring engagements
external network penetration testing engagements
internal network or enterprise infrastructure penetration testing engagements

Each graph may contain nodes and relationships that are associated with a particular project identifier. In some embodiments, each node may include a project identifier attribute that ensures queries executed by the platform only retrieve data associated with the appropriate testing engagement. This design may prevent cross-project data access and ensure strict separation of client data within a multi-tenant testing platform.

### Web Application Security Graph Model

In some embodiments, a graph model may represent web application security reconnaissance and vulnerability analysis. The graph may begin with a domain node representing the primary target domain of the testing engagement. The domain node may be connected to nodes representing subdomains, which may correspond to discovered fully qualified domain names associated with the target domain.

Subdomain nodes may be connected to IP address nodes representing resolved network addresses. Each IP address node may be associated with port nodes representing network ports identified during scanning operations. Port nodes may further connect to service nodes representing software services running on those ports.

Service nodes may be connected to base URL nodes representing reachable HTTP or HTTPS endpoints. Base URL nodes may further connect to endpoint nodes, which may represent specific web application routes, API paths, or application resources discovered during crawling or enumeration processes.

Endpoint nodes may contain parameter nodes representing query parameters, form fields, request body attributes, or path parameters associated with the endpoint. These parameters may represent potential injection points or other input vectors used during vulnerability testing.

The graph may also contain nodes representing detected technologies, such as frameworks, programming languages, libraries, or server software identified during reconnaissance. Technology nodes may be linked to CVE nodes, which represent known vulnerabilities associated with the detected technology. CVE nodes may further connect to nodes representing MITRE Common Weakness Enumeration (CWE) classifications and CAPEC attack pattern identifiers, thereby linking vulnerabilities to known attack techniques and exploitation patterns.

During testing operations, discovered security issues may be represented as vulnerability nodes that are associated with specific endpoints, parameters, services, or hosts. Vulnerability nodes may reference corresponding CVE identifiers where applicable. This structure allows vulnerabilities discovered during testing to be enriched with external vulnerability intelligence sources.

Additional nodes may represent supporting infrastructure elements including:
DNS records associated with subdomains
TLS certificate information associated with HTTPS services
HTTP response headers observed during testing
authentication contexts representing user sessions or tokens
baseline request templates used for automated testing

The graph may therefore represent the full chain of web application discovery from domain enumeration through vulnerability discovery and exploit development.

### External Network Security Graph Model

In some embodiments, the graph database may represent information discovered during external network attack surface monitoring or perimeter security testing.

The root node of the graph may represent a top-level domain (TLD) associated with the organization being tested. The TLD node may connect to nodes representing DNS hostnames or fully qualified domain names discovered during subdomain enumeration processes.

Hostname nodes may connect to IP address nodes representing network hosts reachable from the public internet. Each IP address node may connect to port nodes representing open network ports identified during scanning.

Port nodes may connect to service nodes representing the services detected on those ports. Service nodes may further connect to nodes representing service banners, TLS certificates, and other fingerprinting information obtained during scanning.

Service nodes may also connect to CVE nodes representing vulnerabilities known to affect the service. In some embodiments, the platform may perform vulnerability enumeration processes that map service versions to known CVE identifiers obtained from vulnerability databases.

Confirmed security findings may be represented as vulnerability nodes associated with services or hosts. These vulnerability nodes may reference the corresponding CVE nodes when applicable.

The graph may also represent credential nodes corresponding to discovered credentials obtained through breach data, credential stuffing attempts, or other testing methods. Credential nodes may connect to hosts or services where those credentials are valid.

The platform may also model attack chains, which represent multi-step exploitation paths used to compromise systems. An attack chain node may connect to multiple exploit attempt nodes, each representing a step in the exploitation process. These relationships may include attributes indicating the order of execution of each step in the attack chain.

Additional nodes may represent intelligence sources such as:
phishing domains
breach database records
open source intelligence (OSINT) search results
publicly exposed data discovered through search engines

These nodes may provide additional context during security analysis.

### Internal Network Security Graph Model

In some embodiments, the graph database may represent internal enterprise network environments discovered during internal penetration testing engagements.

The root node may represent a network segment node, which may correspond to a network CIDR range or VLAN within the internal infrastructure. Network segment nodes may connect to host nodes representing systems discovered within the network.

Host nodes may connect to port nodes and service nodes representing services discovered during scanning. Hosts may also connect to nodes representing SMB shares, SNMP data, and DNS records discovered during enumeration.

The graph may also represent Active Directory infrastructure within enterprise environments. Nodes may include:
Active Directory domain nodes
Active Directory user nodes
Active Directory group nodes
Active Directory computer nodes
Group Policy Object (GPO) nodes

These nodes may be connected through relationships representing domain membership, group membership, service principal names, and authentication sessions. For example, a user node may connect to a host node through a relationship indicating that the user has an active session on that host. Similarly, a user node may connect to a host node through a relationship indicating administrative privileges.

Credential nodes may represent credentials discovered or cracked during testing. Credential nodes may connect to hosts or services for which those credentials are valid. Credentials may also connect to user nodes representing the identity associated with the credential.

Vulnerability nodes may represent confirmed security weaknesses affecting hosts or services. Exploit attempt nodes may represent attempts to exploit these vulnerabilities. Exploit attempt nodes may connect to vulnerability nodes, target host nodes, and credential nodes used during the attack.

The graph may also represent lateral movement attack chains, which model the sequence of steps used to escalate privileges or move between systems during an attack. Attack chain nodes may connect to exploit attempt nodes with attributes indicating the order of execution.

Additional nodes may represent captured authentication material, such as NTLM hashes captured during network attacks.

### Agent Coordination and Testing Workflow Representation

In some embodiments, the graph database may also store nodes representing agent tasks that coordinate automated testing activities. Agent task nodes may connect to nodes representing endpoints, parameters, hosts, services, or vulnerabilities that were tested during a penetration testing operation.

These relationships allow the platform to track testing coverage and coordinate activities among multiple automated testing agents operating concurrently. For example, an agent task node may indicate that a particular endpoint or parameter has already been tested for certain vulnerability classes, preventing redundant testing.

The graph database may also store nodes representing scan configuration parameters that define how testing operations are executed within a particular project.

### Knowledge Graph Integration with AI Agents

In some embodiments, the graph database may operate as part of a cybersecurity knowledge graph used by artificial intelligence agents within the penetration testing platform. The knowledge graph may represent discovered infrastructure, vulnerabilities, credentials, and attack paths as interconnected entities.

AI agents may query the graph database to retrieve contextual information relevant to a testing decision. For example, an agent may query the graph to determine:
which services are reachable from a particular host
which vulnerabilities affect a given service
which credentials may allow access to a system
which attack chains may lead to privilege escalation or domain compromise

By representing cybersecurity intelligence within a graph structure, the platform may enable AI agents to reason about relationships between infrastructure components and potential attack paths.

### Graph Database Advantages

The graph-based architecture may provide several advantages over traditional relational data storage methods. Graph structures may allow efficient traversal of relationships among nodes representing infrastructure components, vulnerabilities, and attack techniques. This capability enables rapid identification of potential attack paths and relationships among security findings.

Additionally, the graph structure may allow the platform to represent complex multi-step attack chains, lateral movement paths, and privilege escalation scenarios in a manner that is difficult to represent using traditional relational tables.

As a result, the graph database may serve as a central knowledge representation system that supports automated penetration testing operations, vulnerability analysis, and AI-driven attack path reasoning.

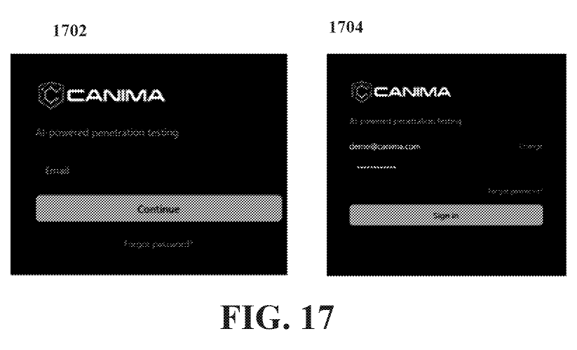

FIG. 17 illustrates example user interface screens 1702 for accessing an AI-driven network security assessment platform. In some embodiments, the interface 1702 includes a login interface configured to receive user authentication information, such as an email address and password, enabling authorized access to the platform. The interface may further include controls for initiating authentication, account recovery options, and branding or informational elements associated with the security assessment system.

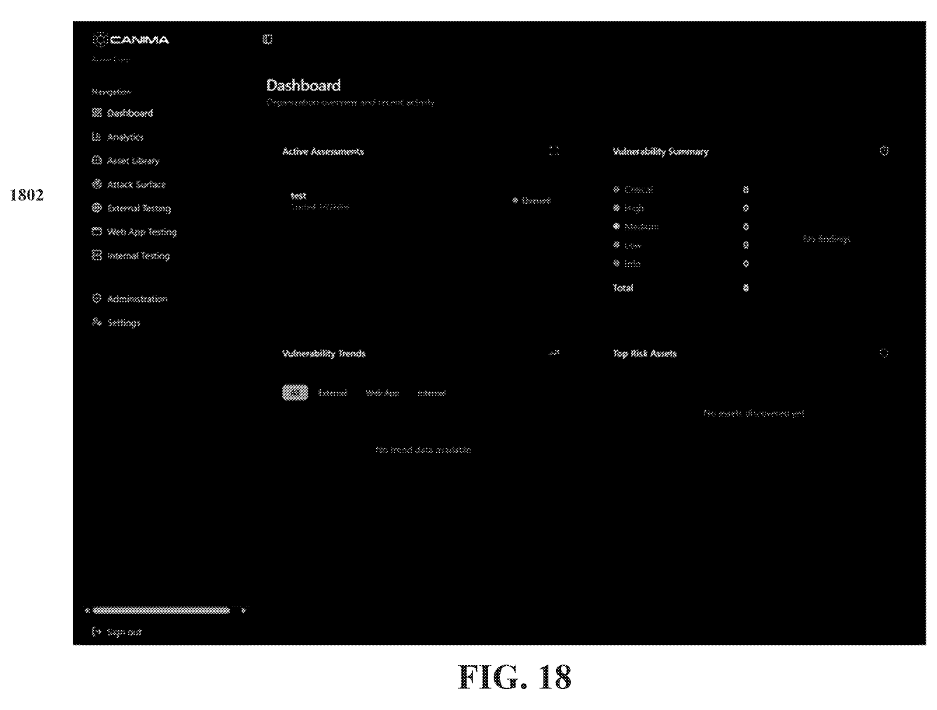

FIG. 18 illustrates an example dashboard interface 1802 of the AI-driven network security assessment platform. In some embodiments, the dashboard interface 1802 provides an overview of organizational security status, including active penetration testing assessments, vulnerability summaries, and risk metrics associated with monitored assets.

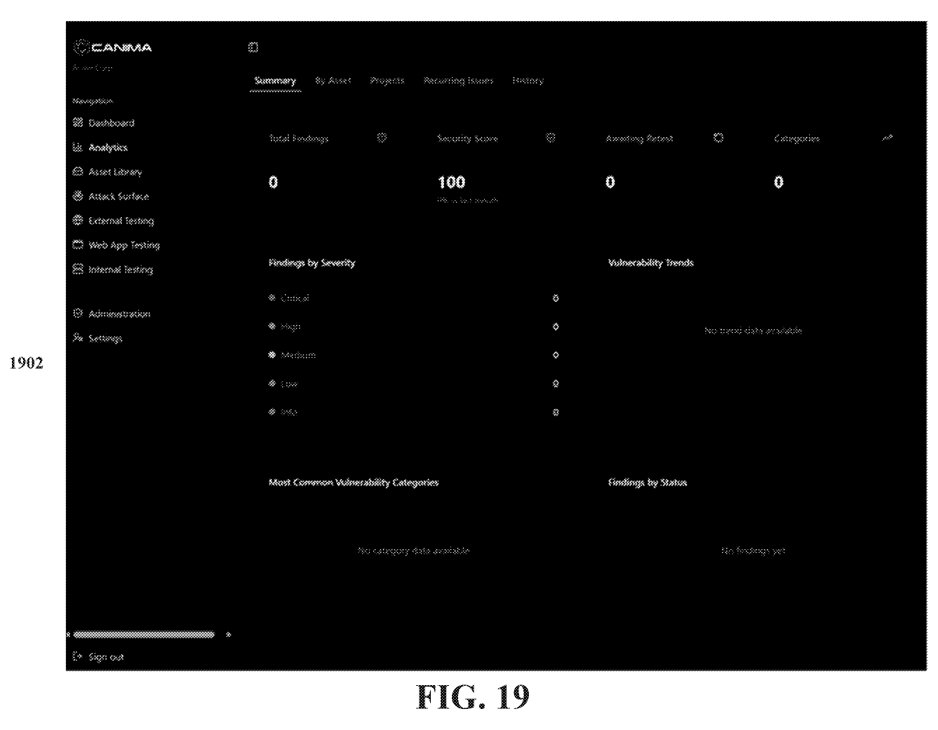

FIG. 19 illustrates an example analytics interface 1902 configured to present security assessment analytics. In some embodiments, the analytics interface 1902 displays vulnerability metrics, security scores, severity distributions, and historical trends associated with penetration testing results.

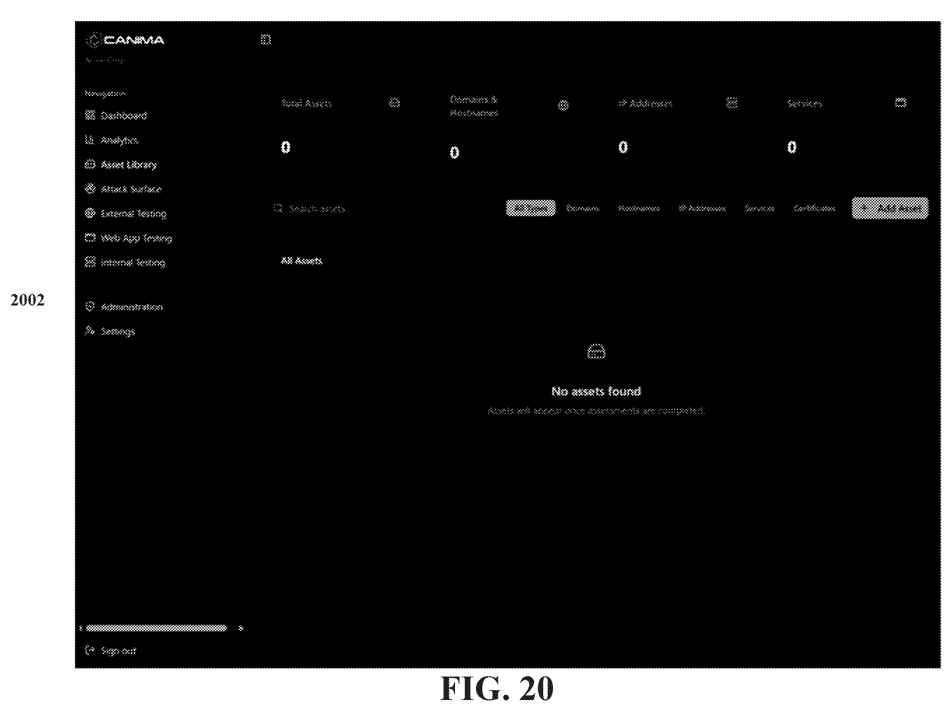

FIG. 20 illustrates an example asset management interface 2002. In some embodiments, the asset management interface 2002 enables users to view, organize, and manage assets associated with a target environment, including domains, hostnames, IP addresses, services, and related infrastructure components identified during reconnaissance.

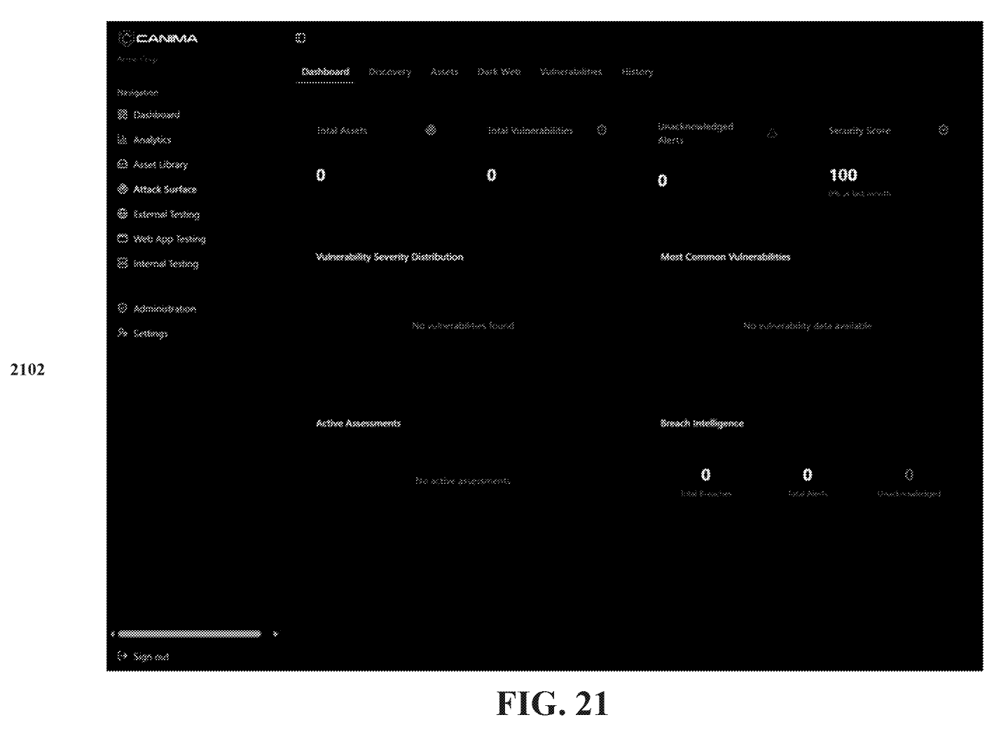

FIG. 21 illustrates an example attack surface monitoring interface 2102. In some embodiments, the interface 2102 presents information relating to discovered assets, vulnerabilities, alerts, and security posture associated with an organization's external attack surface.

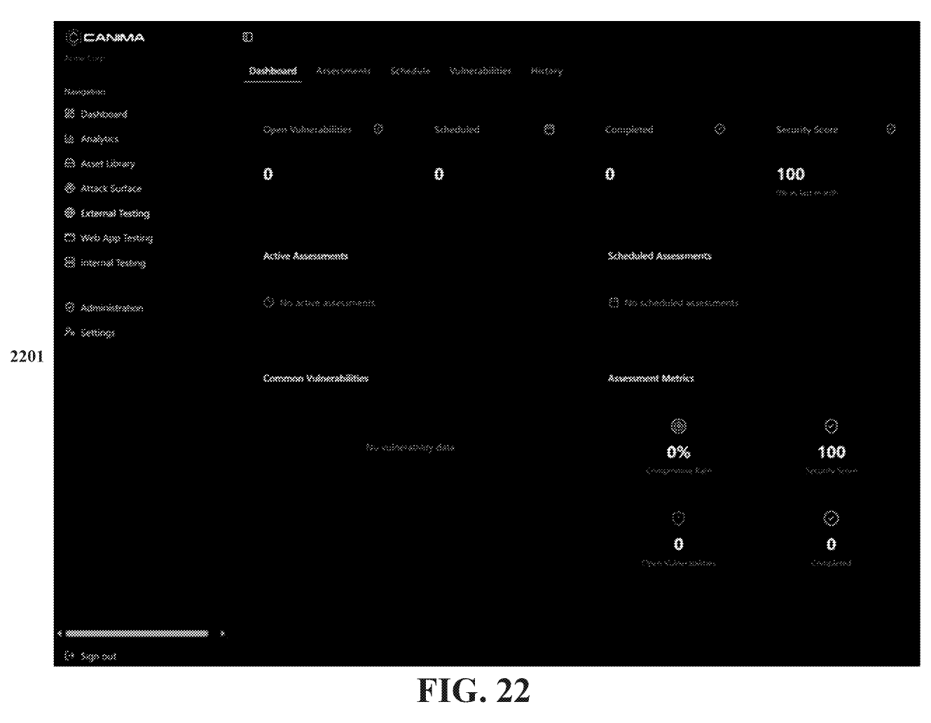

FIG. 22 illustrates an example external testing interface 2202. In some embodiments, the interface 2202 provides visibility into scheduled or active external penetration testing activities, including active assessments, scheduled tests, and metrics associated with security testing outcomes.

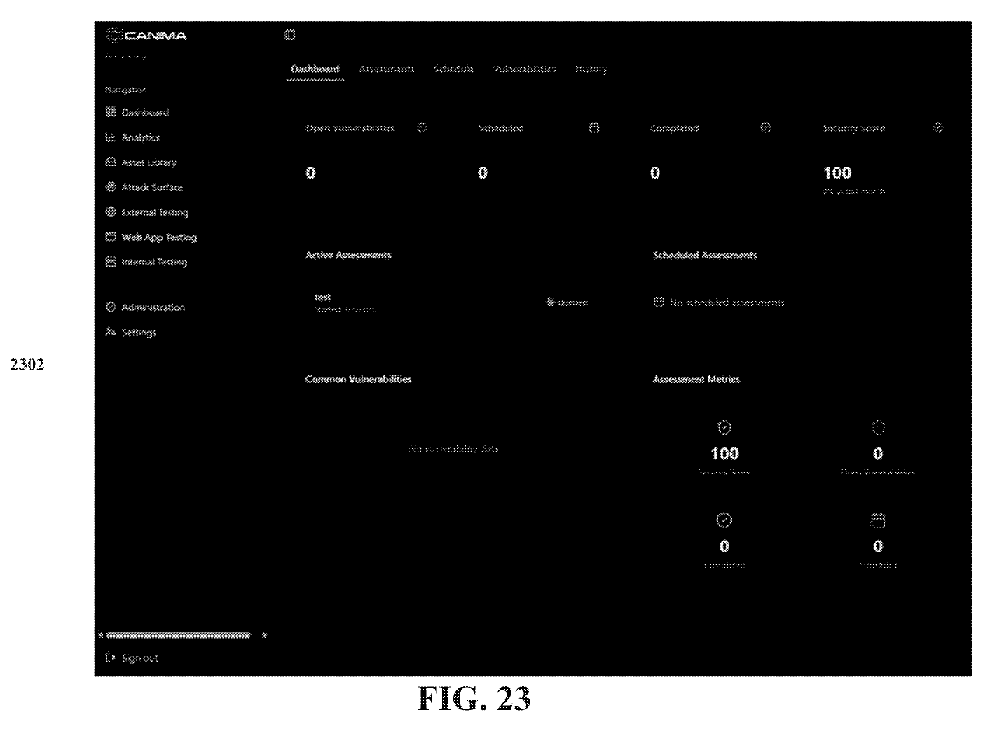

FIG. 23 illustrates an example web application testing interface 2302. In some embodiments, the interface 2302 displays information related to penetration testing of web applications, including active assessments, vulnerability tracking, scheduling information, and testing metrics.

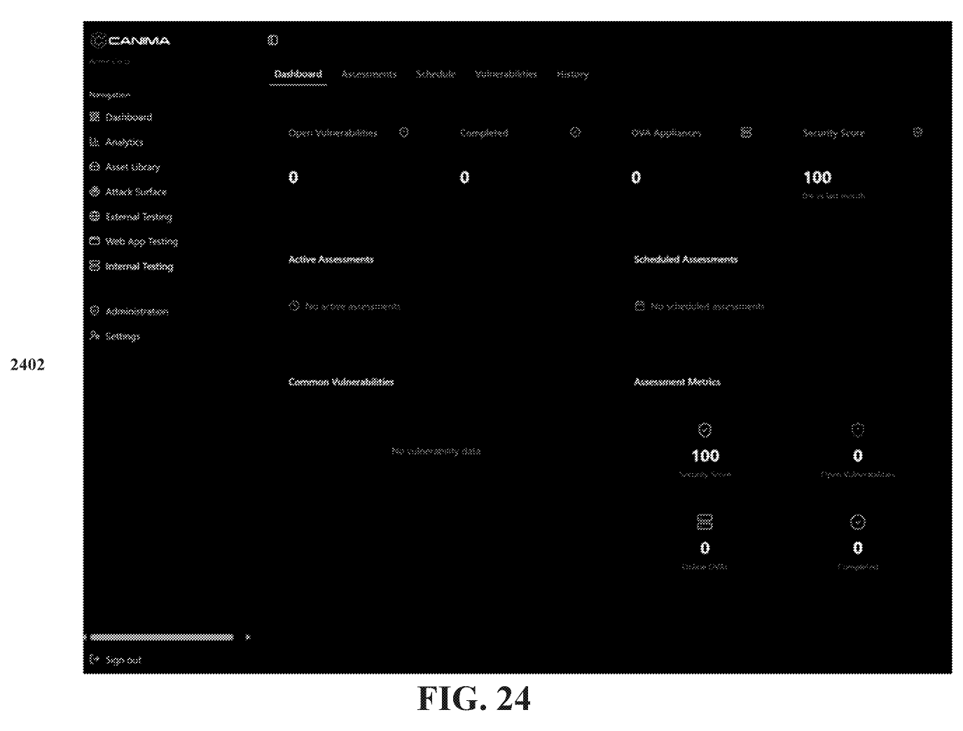

FIG. 24 illustrates an example internal testing interface 2402. In some embodiments, the interface 2402 provides visibility into internal network penetration testing activities, including scheduled tests, completed assessments, and metrics associated with internal security evaluation.

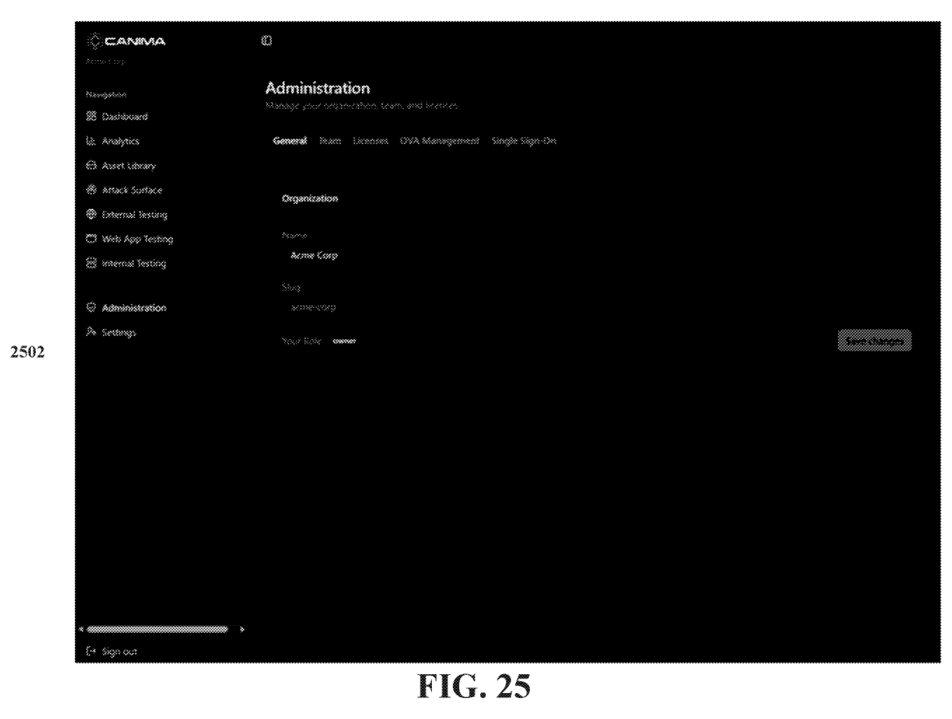

FIG. 25 illustrates an example administrative interface 2502. In some embodiments, the administrative interface 2502 allows authorized users to manage organizational settings, user roles, licenses, authentication options, and system configuration parameters associated with the security assessment platform.

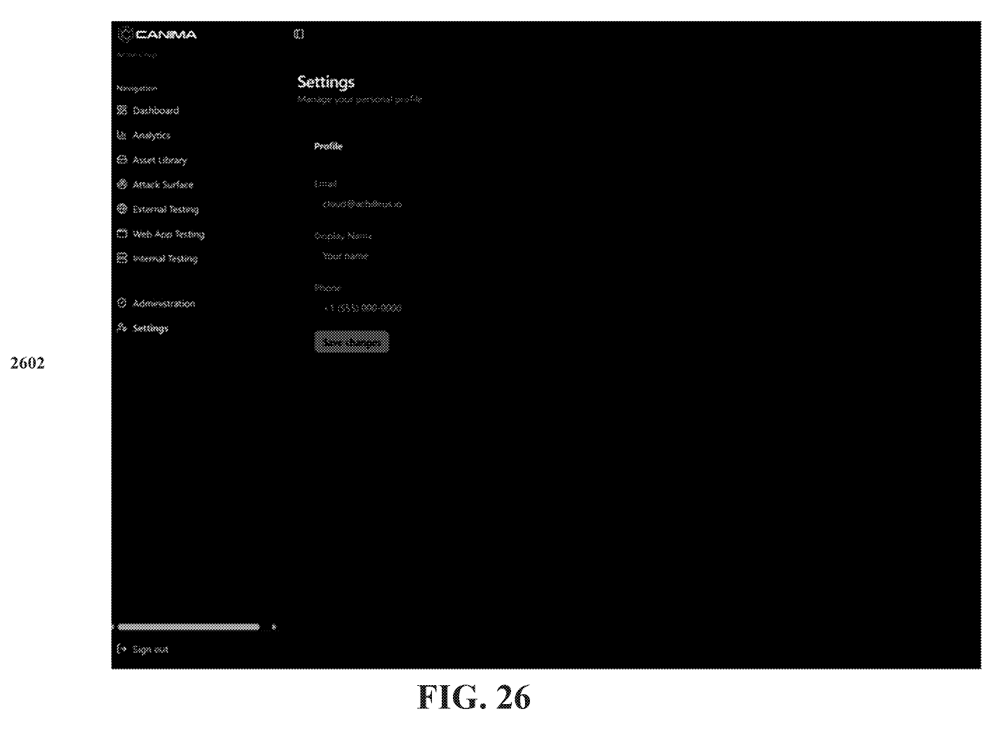

FIG. 26 illustrates an example user settings interface 2602. In some embodiments, the interface 2602 enables users to manage personal account information, including profile details, contact information, and other configurable user preferences associated with the platform.

While several embodiments have been described, it will be appreciated that numerous variations and modifications may be made without departing from the scope of the invention. These may include alternative AI architectures, different attack surface analysis techniques, modifications in the command-and-control framework, and enhancements in exploit execution methodologies. Various implementations may also incorporate different machine learning models, security intelligence feeds, and adaptive risk assessment strategies to further optimize security testing capabilities.

The preceding disclosure provides illustration and description but is not intended to be exhaustive or to limit the implementations to the precise form disclosed. Modifications may be made in light of the above disclosure or may be acquired from practice of the implementations. As used herein, the term “component” is intended to be broadly construed. Although particular combinations of features are recited in the claims and/or disclosed in the specification, these combinations are not intended to limit the disclosure of various implementations. In fact, many of these features may be combined in ways not specifically recited in the claims and/or disclosed in the specification.

Although each dependent claim listed below may directly depend on only one claim, the disclosure of various implementations includes each dependent claim in combination with every other claim in the claim set. No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like) and may be used interchangeably with “one or more.” The phrase “only one” or similar language is used where only one item is intended. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

One or more elements or aspects or steps, or any portion(s) thereof, from one or more of any of the systems and methods described herein, may be combined with one or more elements or aspects or steps, or any portion(s) thereof, from one or more of any of the other systems and methods described herein and combinations thereof, to form one or more additional implementations and/or claims of the present disclosure.

One or more components, steps, features, and/or functions illustrated in the figures may be rearranged and/or combined into a single component, feature, or function. Additional elements, components, steps, and/or functions may also be added without departing from the disclosure. The apparatus, devices, and/or components illustrated in the Figures may be configured to perform one or more of the methods, features, or steps described in the Figures.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification do not necessarily refer to the same embodiment.

The figures and the description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

The foregoing description of the embodiments of the present invention has been presented for the purposes of illustration and description. It is not intended to be exhaustive or to limit the present invention to the precise form disclosed. Many modifications and variations are possible in light of the above teaching. It is intended that the scope of the present invention be limited not by this detailed description, but rather by the claims of this Application. As will be understood by those familiar with the art, the present invention may be embodied in other specific forms without departing from the spirit or essential characteristics thereof. Likewise, the naming and division of the mechanisms, components, and features are not mandatory or significant, and the mechanisms that implement the present invention or its features may have different names, divisions and/or formats.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A system for AI-driven network security assessment, comprising:
a processor; and
a memory storing instructions that, when executed by the processor, cause the system to:
receive a penetration testing request via an API;
schedule execution of a penetration test using a scheduler;
initiate reconnaissance on a target system;
analyze reconnaissance data using a machine learning model with reinforcement learning from human feedback (RLHF);
determine potential vulnerabilities based on the analyzed reconnaissance data;
execute controlled exploit attempts on identified vulnerabilities; and
generate a security report detailing findings and recommended mitigation strategies.

2. The system of claim 1, wherein the scheduler is configured to coordinate penetration tests at predefined intervals.

3. The system of claim 1, wherein the penetration testing request is processed through a command-and-control (C2) infrastructure.

4. The system of claim 1, wherein reconnaissance phase includes scanning at least one of an external attack surfaces, an internal network environments, and a web application.

5. The system of claim 1, wherein the machine learning model dynamically adjusts security assessment parameters based on past test results.

6. The system of claim 1, wherein the controlled exploit attempts are executed in a sandboxed virtual environment.

7. The system of claim 1, further comprising a virtual private network (VPN) infrastructure for secure communication between testing environments.

8. The system of claim 1, wherein the generated security report is stored in a database and accessible via a client portal.

9. The system of claim 1, wherein the security report includes risk classification, exploit success probability, and recommended mitigation steps.

10. The system of claim 1, wherein the machine learning model is updated in real-time based on external threat intelligence feeds.

11. A method for AI-driven network security assessment, comprising:
receiving a penetration testing request via an API;
scheduling execution of the penetration test;
initiating reconnaissance on a target system;
analyzing reconnaissance data using a machine learning model with reinforcement learning from human feedback (RLHF);
determining potential vulnerabilities based on the analyzed reconnaissance data;
executing controlled exploit attempts on identified vulnerabilities; and
generating a security report detailing findings and recommended mitigation strategies.

12. The method of claim 11, wherein the penetration testing request is processed through a command-and-control (C2) infrastructure.

13. The method of claim 11, wherein reconnaissance phase includes scanning at least one of an external attack surfaces, internal network environments, and a web application.

14. The method of claim 11, wherein the machine learning model dynamically adjusts security assessment parameters based on past test results.

15. The method of claim 11, wherein the controlled exploit attempts are executed in a sandboxed virtual environment.

16. The method of claim 11, further comprising encrypting communication between system components using a virtual private network (VPN).

17. The method of claim 11, further comprising storing the security report in a database for retrieval via a client portal.

18. The method of claim 11, further comprising transmitting the security report to an administrator for review and validation.

19. The method of claim 11, further comprising integrating security intelligence feeds into the machine learning model for real-time adaptation.

20. A non-transitory computer-readable medium storing instructions that, when executed by a processor, cause a system to:
receive a penetration testing request via an API;
schedule execution of the penetration test;
initiate reconnaissance on a target system;
analyze reconnaissance data using a machine learning model with reinforcement learning from human feedback (RLHF);
determine potential vulnerabilities based on the analyzed reconnaissance data;
execute controlled exploit attempts on identified vulnerabilities; and
generate a security report detailing findings and recommended mitigation strategies.
